(19) United States
(12) Patent Application Publication
(10) Pub. No.: US 2025/0254637 A1
(43) Pub. Date: Aug. 7, 2025

(54) TIMING SYNCHRONIZATION FOR COMPUTING DEVICES

(71) Applicant: QUALCOMM Incorporated, San Diego, CA (US)

(72) Inventors: Varun Amar REDDY, San Diego, CA (US); Chengjin ZHANG, San Diego, CA (US)

(21) Appl. No.: 18/434,251

(22) Filed: Feb. 6, 2024

(51) Int. Cl. H04W 56/00

(52) U.S. Cl. CPC H04W 56/002; H04W 56/006

(57) ABSTRACT

Systems and techniques are described for establishing timing synchronization for computing devices. For example, an energizing device can synchronize with a network device of a plurality of network devices based on received timing information transmitted from a network entity over a wired connection, a respective received signal strength of a respective beacon transmitted from each network device of the plurality of network devices, and/or a respective received signal strength of a respective beacon transmitted from each wireless communication device of a plurality of wireless communication devices, wherein each wireless communication device of the plurality of wireless communication devices is associated with at least one network device of the plurality of network devices. The energizing device can transmit, to a computing device, an energizer transmission indicating timing (e.g., of a time grid) for synchronization of the computing device to the energizing device.

### FIELD

The present disclosure generally relates to synchronization. For example, aspects of the present disclosure relate to establishing timing synchronization for computing devices, such as timing synchronization for position estimation of ambient internet of things (IOT) devices or tags (e.g., transmit-only ambient IOT tags).

### BACKGROUND

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for establishing timing synchronization for computing devices, such as synchronization for position estimation of transmit-only ambient IOT tags. According to at least one example, an energizing device for wireless communication is provided. The energizing device includes at least one memory and at least one processor coupled to the at least one memory and configured to: synchronize with a network device of a plurality of network devices based on at least one of received timing information transmitted from a network entity over a wired connection, a respective received signal strength of a respective beacon transmitted from each network device of the plurality of network devices, or a respective received signal strength of a respective beacon transmitted from each wireless communication device of a plurality of wireless communication devices, wherein each wireless communication device of the plurality of wireless communication devices is associated with at least one network device of the plurality of network devices; and output, for transmission to a computing device, an energizer transmission indicating timing of a time grid for synchronization of the computing device to the energizing device.

In another illustrative example, a method is provided for wireless communication. The method includes: synchronizing, by an energizing device, with a network device of a plurality of network devices based on at least one of received timing information transmitted from a network entity over a wired connection, a respective received signal strength of a respective beacon transmitted from each network device of the plurality of network devices, or a respective received signal strength of a respective beacon transmitted from each wireless communication device of a plurality of wireless communication devices, wherein each wireless communication device of the plurality of wireless communication devices is associated with at least one network device of the plurality of network devices; and transmitting, by the energizing device to a computing device, an energizer transmission indicating timing of a time grid for synchronization of the computing device to the energizing device.

In another illustrative example, a non-transitory computer-readable medium is provided having stored thereon instructions that, when executed by one or more processors, cause the one or more processors to: synchronize with a network device of a plurality of network devices based on at least one of received timing information transmitted from a network entity over a wired connection, a respective received signal strength of a respective beacon transmitted from each network device of the plurality of network devices, or a respective received signal strength of a respective beacon transmitted from each wireless communication device of a plurality of wireless communication devices, wherein each wireless communication device of the plurality of wireless communication devices is associated with at least one network device of the plurality of network devices; and output, for transmission to a computing device, an energizer transmission indicating timing of a time grid for synchronization of the computing device to the energizing device.

In another illustrative example, an apparatus for wireless communication is provided. The apparatus includes: means for synchronizing with a network device of a plurality of network devices based on at least one of received timing information transmitted from a network entity over a wired connection, a respective received signal strength of a respective beacon transmitted from each network device of the plurality of network devices, or a respective received signal strength of a respective beacon transmitted from each wireless communication device of a plurality of wireless communication devices, wherein each wireless communication device of the plurality of wireless communication devices is associated with at least one network device of the plurality of network devices; and means for transmitting, to a computing device, an energizer transmission indicating timing of a time grid for synchronization of the computing device to the energizing device.

In another illustrative example, a network device for wireless communication is provided. The network device includes at least one memory and at least one processor coupled to the at least one memory and configured to: determine a position for a computing device based on signal strengths measured by a plurality of wireless communication devices of signals transmitted from the computing device; and increase a synchronization accuracy of the plurality of wireless communication devices with the network device and the computing device based on at least one of increasing a frequency of transmission of beacons by the network device, or indicating to a subset of wireless communication devices of the plurality of wireless communication devices located in proximity to the position for the computing device to wake up to receive transmissions more frequently than scheduled according to a predetermined time grid.

In another illustrative example, a method is provided for wireless communication. The method includes: determining, by a network device, a position for a computing device based on signal strengths measured by a plurality of wireless communication devices of signals transmitted from the computing device; and increasing, by the network device, a synchronization accuracy of the plurality of wireless communication devices with the network device and the computing device based on at least one of increasing a frequency of transmission of beacons by the network device, or indicating to a subset of wireless communication devices of the plurality of wireless communication devices located in proximity to the position for the computing device to wake up to receive transmissions more frequently than scheduled according to a predetermined time grid.

In another illustrative example, a non-transitory computer-readable medium is provided having stored thereon instructions that, when executed by one or more processors, cause the one or more processors to: determine a position for a computing device based on signal strengths measured by a plurality of wireless communication devices of signals transmitted from the computing device; and increase a synchronization accuracy of the plurality of wireless communication devices with the network device and the computing device based on at least one of increasing a frequency of transmission of beacons by the network device, or indicating to a subset of wireless communication devices of the plurality of wireless communication devices located in proximity to the position for the computing device to wake up to receive transmissions more frequently than scheduled according to a predetermined time grid.

In another illustrative example, an apparatus for wireless communication is provided. The apparatus includes: means for determining, by a network device, a position for a computing device based on signal strengths measured by a plurality of wireless communication devices of signals transmitted from the computing device; and means for increasing, by the network device, a synchronization accuracy of the plurality of wireless communication devices with the network device and the computing device based on at least one of increasing a frequency of transmission of beacons by the network device, or indicating to a subset of wireless communication devices of the plurality of wireless communication devices located in proximity to the position for the computing device to wake up to receive transmissions more frequently than scheduled according to a predetermined time grid.

Some aspects include a device having at least one processor (one processor or multiple processors) configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a diagram illustrating an example of an enterprise resource planning (ERP) system infrastructure, in accordance with aspects of the present disclosure.

FIG. 4 is a signaling diagram illustrating example communication transmissions, in accordance with some aspects of the present disclosure.

FIG. 5 is a signaling diagram illustrating an example of communication transmissions between a network device and two groups of wireless communication devices, in accordance with some aspects of the present disclosure.

FIG. 6 is a signaling diagram illustrating an example of communication transmissions for synchronization between network devices and energizing devices, in accordance with some aspects of the present disclosure.

FIG. 7 is a signaling diagram illustrating an example of communication transmissions for synchronization between wireless communication devices and ambient IOT devices, in accordance with some aspects of the present disclosure.

FIG. 8 is a flow diagram illustrating an example of a process for synchronization, which may be performed at an energizing device, in accordance with some aspects of the present disclosure.

FIG. 9 is a flow diagram illustrating an example of a process for synchronization, which may be performed at a network device, such as an access point, in accordance with some aspects of the present disclosure.

FIG. 10 is a block diagram illustrating an example of a computing system, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Short range wireless communication protocols enable wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz. BLUETOOTH® Low Energy (BLE) is a form of BLUETOOTH® communication that allows for communication with devices that operate using low power. Such devices may include beacons, which are wireless communication devices that can use low-energy communication technology for positioning, proximity marketing, or other purposes.

A system may include one or more wireless communication devices that are controlled by a network entity. For example, a system including multiple peripheral devices (e.g., an electronic shelf label (ESL) system) may include one or more wireless communication devices (e.g., peripheral devices, such as ESLs) that are controlled by a network entity, such as a management entity (ME) or edge server, via at least one network device, such as an access point (AP). As used herein, the terms “network entity” and “network device” may be interchangeable. For example, an AP can be referred to as an example of a “network entity” and/or can be referred to as an example of a “network device.” A “network entity” can include an AP, an ME, and/or a combination of the two. A “network device” can include an AP, an ME, and/or a combination of the two. In some examples, a single device can implement the functionality of an ME and an AP (e.g., an ME and an AP can be combined in a single device).

In one or more examples, to facilitate control by the ME (e.g., edge server), each peripheral device (e.g., ESL) may have a wireless connection (e.g., a BLE connection or other connection) to an AP that is communicatively connected to the ME (e.g., via the Internet, such as wirelessly, via an Ethernet connection, etc.). In some cases, commands from the ME may be wirelessly transmitted to the peripheral devices (e.g., ESLs) by the AP. Responses or information from the peripheral devices may also be received by the AP and provided by the AP to the ME.

In ESL systems, periodic Advertisements (PAs) can be utilized to provide regular and predictable payload transmissions from a central device (e.g., which may be in the form of a network device, such as an AP) to one or more peripheral devices (e.g., which may each be in the form of a wireless communication device, such as an ESL or other peripheral device). For example, PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) can be used for systems (e.g., ESL systems) to provide bidirectionality (e.g., bidirectional transmissions between a central device and one or more peripheral devices). Peripheral devices synchronized within a group of peripheral devices can be addressed by a central device on a synchronized channel (e.g., a radio frequency (RF) channel between the central device and the peripheral devices) whenever the central device determines to send (e.g., transmit) a request to the peripheral devices. In some cases, as used herein, a synchronized channel refers to a channel on which transmissions are synchronized (in time). For example, the channel can utilize or can be based on a frequency on which one or more communications are transmitted. A hopping frequency sequence (HFS) can be associated with the channel. In some cases, the HFS may progress at a fixed and/or pre-determined interval. In some cases, a channel map may change, such as if interference on one or more channels changes, in which case the HFS can be updated (there may not be a fixed interval). In such cases, a minimum time between updates of a HFS can be applied, which can avoid updating the HFS too frequently. A central device and one or more peripheral devices can concurrently track the sequence at a predefined frequency hopping pattern or sequence (e.g., so the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

In some cases, each access point may have an associated channel map. A channel map is a listing of frequency channels to be utilized or, conversely, not to be utilized (e.g., in the context of modification of frequency hopping sequences) by an access point for communication, such as with the ESLs or other devices. For example, for a particular PA train, PA packets can be transmitted on a particular number of channels (e.g., 37 data channels). The channels that are used and the channels that are not used can be indicated by the channel map. The channel map of an access point can be updated via a channel map update (CMU). A CMU is a procedure for updating (or changing) a current channel map (ChM) for an access point to a new channel map for the access point. As noted previously, the access point can send a synchronization message as a PA to the ESLs. The synchronization message can include various types of information, including information associated with a CMU in addition to other information. For example, when an access point is performing a CMU, information associated with the CMU can be included in one or more fields (e.g., an Additional Controller Advertising Data (ACAD) field) of a synchronization message. The CMU information included in a synchronization message can notify one or more ESLs of the new channel map to be used for future communications with the access point.

In some cases, an ESL may lose synchronization with (e.g., due to being out of communications range) a current access point for which the ESL is associated. Such a loss in synchronization may interrupt the management entity's ability to control the ESL and the ESL's ability to report to the management entity. After determining a network outage (e.g., caused by the loss of synchronization), the ESL may perform an onboarding procedure to reestablish synchronization with an access point. PAwR allows BLE peripheral devices (e.g., ESLs) to perform an onboarding procedure to synchronize with a central device (e.g., an access point) and, as such, be able to respond to periodic transmissions from the central device. For example, for an onboarding procedure in a retail setup (e.g., within a retail store or warehouse environment), an access point can act as a central device, and ESLs can act as peripheral devices. When the ESLs are powered, the ESLs can scan to receive a wake up packet (WUP) from the access point. The WUP can contain advertisement parameters for the ESLs. Upon receiving the WUP from the access point, the ESLs can transmit advertisement messages (e.g., a connectable advertisement (CAP)) on a legacy channel based on parameters (e.g., interval and duration parameters) received within the WUP. The access point can scan to receive the CAPs from the ESLs, and then create a generic attribute profile (GATT) connection with one of the advertising ESLs to perform onboarding of that ESL. The onboarding process involves the transfer of periodic advertisement synchronization transfer (PAST) information, where an access point can share its PAwR timing with the ESL. When multiple access points receive a CAP from an ESL, the access points can report the received CAP to the management entity. The management entity can then shortlist one of the access points to onboard the ESL.

A system, such as an enterprise resource planning (ERP) system (e.g., for asset tracking, monitoring, and/or supply chain management purposes, such as in a retail store or warehouse environment), may include one or more wireless communication devices that are controlled by a network entity. For example, a system may include one or more peripheral devices (e.g., wireless communication devices, such as in the form of ESLs) that are controlled by a network entity (e.g., an ERP server) via at least one network device (e.g., an access point). In one or more examples, to facilitate control by the network entity (e.g., the ERP server), each peripheral device (e.g., ESL) may have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., the ERP server) may be wirelessly transmitted to the peripheral devices (e.g., ESLs) by the network device (e.g., the access point). Responses or information from the peripheral devices may also be received by the network device, and provided by the network device to the network entity (e.g., by the access point to the ERP server).

The peripheral devices in the system may include a plurality of ambient internet of things (IOT) devices (as examples of wireless communication devices or peripheral devices), which may each be in the form of a low cost, batteryless, energy harvesting tag. One or more of the ambient IOT devices (e.g., tags) can each be attached to an asset located within a location (e.g., a retail store, a warehouse, etc.) for asset tracking, monitoring, and/or supply chain management purposes. Devices, such as devices for energizing (e.g., which may be referred to as “energizing devices”, “energizers”, or “readers”), can interrogate, scan, read, probe, and/or energize the ambient IOT devices. Such devices can be in the form of mobile devices (e.g., smart phones, tablet computers, handheld reader devices, etc.), robots, forklifts, or other devices.

The ambient IOT devices (e.g., being batteryless) may be powered by harvesting energy (e.g., power) from signals (e.g., energizing signals, RF signals, sweeping beams, or energizing waveforms) transmitted from the devices (such as energizing devices). After being energized, the ambient IOT devices can each transmit a response signal including some identifying information (e.g., metadata) that is unique to each ambient IOT device. Near field communication (NFC) tags can support communication as well. An ERP server may store and maintain a database of information pertaining to the ambient IOT devices (e.g., information related to their capabilities and last known locations).

Generally, the ambient IOT devices are transmit-only devices, whose transmissions cannot be deterministically scheduled (e.g., to avoid interference). The ambient IOT devices continuously transmit beacons causing the wireless communication devices (e.g., ESLs) to keep waking up to receive the beacons. The wireless communication devices (e.g., ESLs) need to be activated/woken up in a strategic manner to receive multiple tag transmissions without draining their battery resources (e.g., ESLs are typically battery powered and, as such, power constrained). Therefore, timing synchronization is needed between the network devices (e.g., access points), wireless communication devices (e.g., ESLs), energizing devices, and ambient IOT devices (e.g., ambient IOT tags).

As such, improved systems and techniques (e.g., along with associated message flows) that can achieve an accurate (e.g., tight) synchronization between the network devices (e.g., access points), wireless communication devices (e.g., ESLs), energizing devices, and ambient IOT devices (e.g., ambient IOT tags) can be beneficial. Systems and techniques that provide coarse position estimates for the ambient IOT devices to ensure an even more accurate (e.g., tighter) synchronization between the ambient IOT devices and the intended destination wireless communication devices (e.g., ESLs) can also be useful.

In one or more aspects of the present disclosure, systems, apparatuses, methods (also referred to as processes), and computer-readable media (collectively referred to herein as “systems and techniques”) are described herein that provide solutions for establishing timing synchronization for computing devices. For example, the systems and techniques can provide synchronization for position estimation of transmit-only ambient IOT tags (e.g., in smart retail, for smart warehousing solutions, for automotive applications, among other use cases).

Various aspects relate generally to synchronization. Some aspects more specifically relate to systems and techniques that provide an accurate (e.g., tight) synchronization between network devices (e.g., access points), wireless communication devices (e.g., ESLs), energizing devices (e.g., energizers), and ambient IOT devices (e.g., ambient IOT tags). In one or more aspects, an energizing device (e.g., an energizer) can synchronize its timing with a network device (e.g., an access point) via a wired connection, or via beacons transmitted wirelessly from the network device (e.g., the access point) or from wireless communication devices (e.g., ESLs) associated with the network device (e.g., the access point). When there are multiple network devices (e.g., access points) detected by an energizing device, a network device (e.g., access point) can be selected for synchronization, based on the strongest signal strength (e.g., a received signal strength indicator (RSSI)) from the network device (e.g., access point) and/or based on strong signal strengths from a subset of wireless communication devices (e.g., ESLs) such that the network device (e.g., access point) associated with the subset of wireless communication devices would be selected. In some aspects, an ambient IOT device (e.g., an ambient IOT tag) can transmit its beacon within an ESL receive (Rx) time window, where this beacon transmission may occur at the end of an energizer transmission or at an ON/OFF pattern in a waveform of an energizer transmission. In one or more examples, based on a coarse location of an ambient IOT device(s), a corresponding network device (e.g., access point) may increase the synchronization accuracy of wireless communication devices (e.g., ESLs) by increasing its frequency of beacon transmissions and/or by indicating to a subset of wireless communication devices (e.g., ESLs), which are located within the vicinity of the estimated coarse location(s) of the ambient IOT device(s), to wake up to receive transmissions more frequently.

In one or more examples, during operation of the systems and techniques for synchronization, an energizing device (e.g., an energizer) can synchronize with a network device (e.g., an access point) of a plurality of network devices (e.g., access points), based on received timing information transmitted from a network entity (e.g., an edge server) over a wired connection, based on received signal strengths (e.g., RSSIs) of beacons transmitted from the plurality of network devices, based on received signal strengths (e.g., RSSIs) of beacons from a plurality of wireless communication devices (e.g., ESLs) associated with the plurality of network devices. In one or more examples, the timing information may be associated with the network device (e.g., access point). In some examples, the signal strength (e.g., RSSI) of the beacon transmitted from the network device of the plurality of network devices is greater than the signal strengths of the beacons transmitted from other network devices of the plurality of network devices. In one or more examples, a subset of the wireless communication devices of the plurality of wireless communication devices can be associated with the network device. In some examples, the signal strengths (e.g., RSSIs) of the beacons transmitted from the subset of wireless communication devices of the plurality of wireless communication devices are greater than the signal strengths of the beacons transmitted from other wireless communication devices of the plurality of wireless communication devices. In one or more examples, each beacon of the beacons transmitted by the plurality of wireless communication devices can include an identification (ID) of an associated network device of the plurality of network devices. The energizing device can transmit, to an ambient device (e.g., an ambient IOT device or tag), an energizer transmission indicating timing (e.g., of a time grid) for synchronization of the ambient device to the energizing device. In one or more examples, an end of the energizer transmission can indicate a boundary between time slots of a time grid associated with the timing for the synchronization of the computing device to the energizing device. In some examples, the energizer transmission can include a waveform with a pattern indicating a boundary between time slots of the time grid.

In some examples, during operation of the systems and techniques for synchronization, a network device (e.g., an access point) can determine a position for an ambient device (e.g., an ambient IOT device or tag) based on signal strengths (e.g., RSSIs) measured by a plurality of wireless communication devices (e.g., ESLs) of signals transmitted from the ambient device. The network device can increase a synchronization accuracy of the plurality of wireless communication devices with the network device and the ambient device based on increasing a frequency of transmission of beacons by the network device, and/or based on indicating to a subset of wireless communication devices of the plurality of wireless communication devices located in proximity to the position for the ambient device to wake up to receive transmissions more frequently than scheduled according to a predetermined time grid.

Particular aspects of the subject matter described in this disclosure can be implemented to realize one or more of the following potential advantages. In some examples, the systems and techniques can provide an improvement in synchronization accuracy between network devices (e.g., access points), wireless communication devices (e.g., ESLs), energizing devices (e.g., energizers), and ambient IOT devices (e.g., ambient IOT tags). The improvement in synchronization between ambient IOT devices (e.g., ambient IOT tags) and wireless communication devices (e.g., ESLs) can allow for a reduction in power consumption by the wireless communication devices (e.g., ESLs) because the wireless communication devices (e.g., ESLs) can be activated/woken up in a strategic manner (e.g., using the synchronization to a common time grid) to receive the ambient IOT devices transmissions without draining the battery resources of the wireless communication devices (e.g., ESLs).

Additional aspects of the present disclosure are described in more detail below.

As used herein, the term “RF signal” includes an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

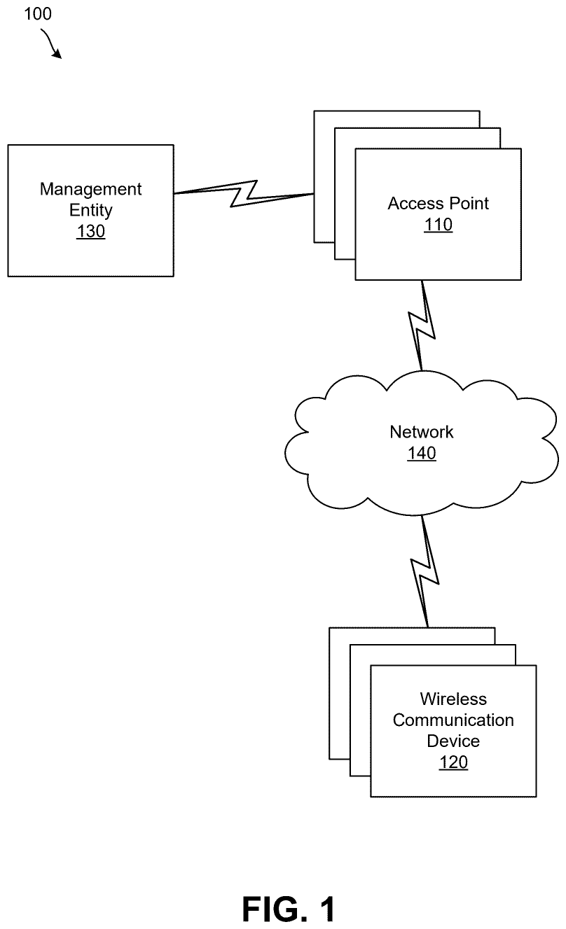

According to various aspects, FIG. 1 is a diagram of an example environment 100 in which systems and/or methods described herein may be implemented. As shown in FIG. 1, the environment 100 may include at least one access point (AP) 110 (e.g., a network device), at least one wireless communication device 120 (e.g., at least one ESL), a management entity (ME) 130 (e.g., a network entity), and a network 140. Devices of the environment 100 may interconnect via wired connections, wireless connections, or a combination of wired and wireless connections.

The access point 110 may include one or more devices capable of receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

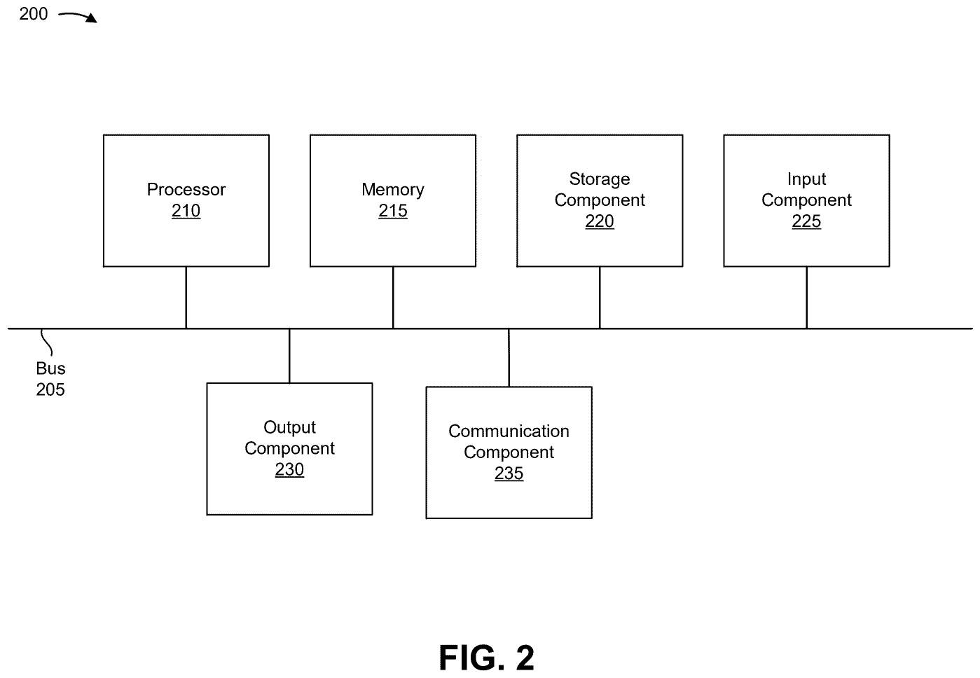

FIG. 2 is a diagram illustrating example components of a device 200, in accordance with the present disclosure. Device 200 may correspond to access point 110, wireless communication device 120 (e.g., an ESL), and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., an indoor location component or system that can be based on a plan-o-gram of an environment in which the device 200 is located, a global positioning system (GPS) component, a global navigation satellite system (GNSS) component, any combination thereof, and/or other location component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

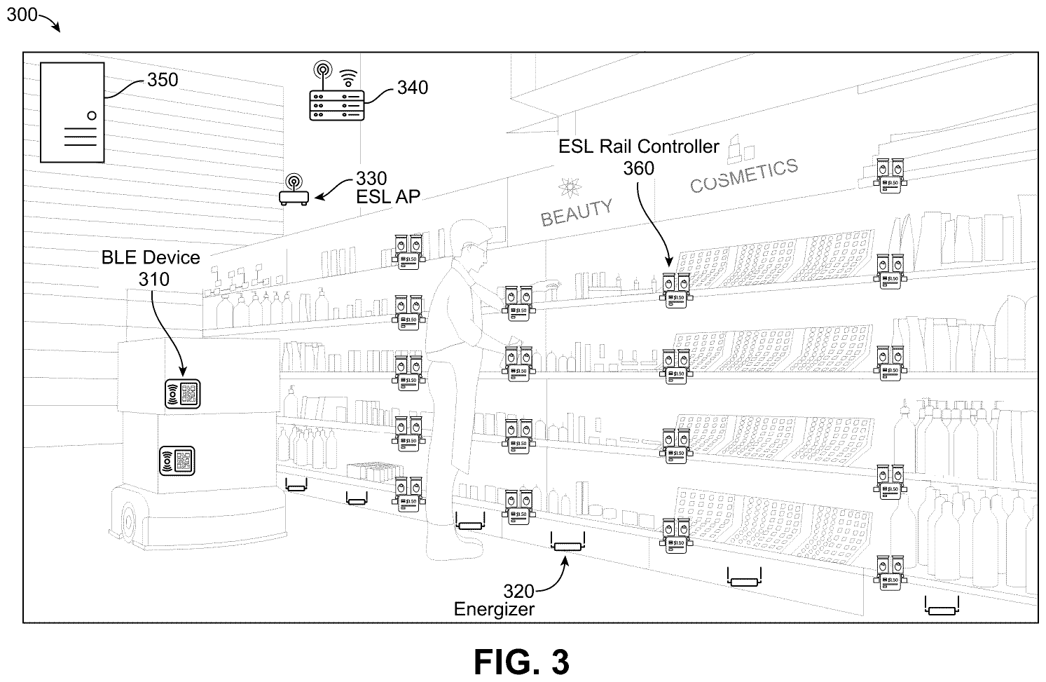

As previously mentioned, a system, such as an enterprise resource planning (ERP) system (e.g., for asset tracking, monitoring, and/or supply chain management purposes, such as in a retail store or warehouse environment), can include one or more wireless communication devices that are controlled by a network entity. For example, a system may include one or more peripheral devices (e.g., wireless communication devices, such as wireless communication devices 120 of FIG. 1, for example in the form of ESLs) that are controlled by a network entity (e.g., an ERP server, such as network entity 350 of FIG. 3) via at least one network device (e.g., an access point, such as access point 110 of FIG. 1). In one or more examples, to facilitate control by the network entity (e.g., the ERP server), each peripheral device (e.g., ESL) can have a wireless connection (e.g., a BLE connection or other connection) to the network device (e.g., the access point) that is communicatively connected to the network entity (e.g., via the Internet, such as wirelessly, via an Ethernet connection, etc.). In some cases, commands from the network entity (e.g., the ERP server) can be wirelessly transmitted to the peripheral devices (e.g., ESLs) by the network device (e.g., the access point). Responses or information from the peripheral devices can also be received by the network device, and provided by the network device to the network entity (e.g., by the access point to the ERP server).

The peripheral devices in the system can include a plurality of ambient IOT devices (as examples of wireless communication devices or peripheral devices), which may each be in the form of a low cost, batteryless, energy harvesting tag. One or more of the ambient IOT devices (e.g., ambient IOT tags) may each be attached to an asset located within a location (e.g., a retail store, a warehouse, etc.) for asset tracking, monitoring, and/or supply chain management purposes. Devices, such as devices for energizing (e.g., which may be referred to as “energizing devices”, “energizers”, or “readers”), may interrogate, scan, read, probe, and/or energize the ambient IOT devices. Such devices may be in the form of mobile devices (e.g., smart phones, tablet computers, handheld reader devices, etc.), robots, forklifts, or other devices.

The ambient IOT devices, being batteryless, can be powered by harvesting energy (e.g., power) from signals (e.g., energizing signals, RF signals, sweeping beams, or energizing waveforms) transmitted from the devices (e.g., energizing devices). After being energized, the ambient IOT devices may each transmit a response signal including some identifying information (e.g., metadata) that is unique to each ambient IOT device. NFC tags may support communication as well. An ERP server can store and maintain a database of information pertaining to the ambient IOT devices (e.g., information related to their capabilities and last known locations).

In one or more aspects, an ERP system infrastructure (e.g., including energizing devices) can be utilized to trigger ambient IOT devices to send response signals including their respective identifying information. In one or more examples, ambient IOT devices of an ERP system infrastructure may be configured to transmit beacon frames (e.g., response signals, which may include identifying information associated with the ambient IOT devices).

FIG. 3 shows an example of system infrastructure. In particular, FIG. 3 is a diagram illustrating an example of an ERP system infrastructure 300. In FIG. 3, the infrastructure 300 is shown to be located within a retail store. The infrastructure is shown to include a network entity 350 (e.g., in the form of an ERP server or cloud server, which may be located remotely from the retail store), a network entity 340 (e.g., in the form of an edge server or gateway node, which may be located within the retail store), a network device 530 (e.g., an access point, which may be located within the retail store), ambient IOT devices 310 (e.g., energy harvesting BLE tags that are each associated with a parcel), energizing devices 320 (e.g., energizers mounted on the shelving units within the retail store), and wireless communication devices 360 (e.g., in the form of ESLs that are mounted on the shelving units, where the ESLs are powered and controlled by an electric rail mounted within the shelving units).

In one or more aspects, the energizing devices 320 (e.g., energizers mounted on a shelf, mobile devices, such as a smart phone, a robot, a fork lift, etc.) may have one or more capabilities. In one or more examples, the energizing devices 320 may have a capability of supporting RFID technology, which may include the ability to read and scan an ambient IOT device 310 (e.g., in the form of an RFID tag), and include the ability to support communications using one or more frequency bands related to RFID technology, such as low frequency (LF), high frequency (HF), near field communication (NFC) frequency, and ultra-high frequency (UHF). In some examples, the energizing devices 310 may have an energizing capability, which can include the ability to energize an ambient IOT device 310 and to instruct the ambient IOT device 310 to communicate (e.g., via a broadcast or a unicast) with another device (e.g., communicate information about a particular item to an access point, such as for inventory purposes). In one or more examples, the energizing devices 320 may have a capability to support beamforming (e.g., a beamforming capability to be able to form an antenna beam and scan the beam towards a particular ambient IOT device 310), such as for the purpose of interrogating the ambient IOT device 310.

In one or more examples, the energizing devices 320 may have a capability to support radio communications, such as radio frequency (RF) communications (e.g., using cellular, satellite, Wi-Fi, and/or Bluetooth communications). For example, the energizing devices 320 may be able to receive transmissions (e.g., RF signal transmissions) from one or more ambient IOT devices 310 (e.g., each in the form of a tag), such as for the purpose of relaying the received information to a network device 330 (e.g., access point), a network entity 340 (e.g., an edge server) and/or an ERP system (e.g., network entity 350, such as an ERP server).

In some examples, the energizing devices 320 may have a capability of including a camera for capturing images and/or video of the surrounding environment (e.g., within the retail store or warehouse). The energizing devices 320 may receive information (e.g., about a product associated with an ambient IOT device 310e) via images taken by the camera of the local environment.

In one or more examples, the energizing devices 320 may have a capability of having transparency, which may include an ability to share information associated with one or more ambient IOT devices 310, which may each be in the form of a tag, with an external server, such as the ERP system (e.g., network entity 350, such as an ERP server). In some examples, the energizing devices 320 may have the capability to share information (e.g., prices, expiration dates, and/or online reviews related to the items associated with the ambient IOT devices 310) to a user or a store employee by displaying the information on a graphical user interface (GUI), which may be implemented within the energizing devices 320. In one or more examples, when an energizing device 320 is able to share information associated with one or more ambient IOT devices 310, there may be an expected latency (e.g., an expected amount of delay in time) in the energizing device 320 delivering the information to the ERP system (e.g., network entity 350, such as an ERP server).

In one or more aspects, ambient IOT devices 310, which may each be in the form of a tag, may have one or more capabilities. In one or more examples, the ambient IOT devices 310 may be part of a larger system, such as a system that includes wireless communication devices 360 (e.g., ESLs) and/or rail controllers, which may each be equipped with wireless radios (e.g., RF radios) and/or cameras.

In one or more examples, the ambient IOT devices 310 may have one or more of the same capabilities as previously mentioned for the energizing devices 320, except for the energizing and beamforming capabilities. For example, the ambient IOT devices 310 may have capabilities including the ability to support RFID technology (e.g., which can include the ability to harvest energy from received signals (energizer signals or transmissions) from energizing devices 320 and to transmit identifying information after being sufficiently energized with power), the ability to operate as a radio (e.g., the ability to receive transmissions from energizing devices 320 and to transmit signals to the energizing devices 320 and/or to the wireless communication devices 360), the ability to operate as a camera, and/or the ability to operate with transparency (e.g., by sharing identifying information for itself with energizing devices 320).

In one or more aspects, the energizing devices 320 may have different states or modes of operation. In the one or more examples, the different states or modes of operation may include an omnidirectional state or mode, a directional state or mode, a beam sweep state or mode, and/or an inactive state or mode. In one or more examples, the omnidirectional state or mode may be a state or mode where the energizing device 320 scans one or more antennas associated with the energizing device 320 in all directions (e.g., to form an omnidirectional antenna beam pattern). In some examples, the directional state or mode may be a state or mode where the energizing device 320 forms an antenna beam and scans the beam in a specific direction (e.g., analog beamforming). In one or more examples, the beam sweep state or mode may be a state or mode where the energizing device 320 forms a set of antenna beams, where each beam is a directional beam, and scans the set of beams. In some examples, the inactive state or mode may be a state or mode where the energizing device 320 is not operational (e.g., the energizing device is powered off).

In one or more aspects, the energizing devices 320 may jointly perform beam sweeping over a certain region and trigger the ambient IOT devices 310 (e.g., to send response signals including identifying information) located within that region. In one or more examples, the energizing devices 320 can trigger the ambient IOT devices 310, based on a type of the ambient IOT devices 310, a region for location of the ambient IOT devices 310, a region centered around a specific location for the ambient IOT devices 310, on certain period of time, or a certain number of transmissions. In one or more examples, the beam sweeping may be performed in an efficient non-overlapping manner such that different energizing devices 320 do not energize the same set of the ambient IOT devices 310 (e.g., tags).

During operation of the infrastructure 300 of FIG. 3 within a particular environment (e.g., a retail environment, a warehouse, an automotive environment with multiple vehicles, among other use cases), the energizing devices 320 can send (e.g., transmit) energizer signals (e.g., energizer transmissions) to the ambient IOT devices 310. The ambient IOT devices 310 can receive the energizer signals and harvest energy from the energizer signals to energize themselves. After the ambient IOT devices 310 have harvested enough energy to be able to transmit, the ambient IOT devices 310 (e.g., tags) can send (e.g., transmit) beacon frames. In one or more examples, the ambient IOT devices 310 can be configured to transmit beacon frames for a certain period of time or for a certain number of transmissions, based on a waveform of the received energizer signals (e.g., energizer transmission) transmitted from the energizing devices 320.

In one or more examples, the wireless communication devices 360 (e.g., ESLs), which are located within the vicinity of the ambient IOT devices 310 (e.g., tags), can receive the beacon frames transmitted from the ambient IOT devices 310 (e.g., tags). In some examples, receivers (e.g., associated with the wireless communication devices 360) may receive the beacon frames, may obtain information from the beacon frames (e.g., information related to the ambient IOT devices 310 themselves, such as unique identifying information, and/or information related to items or product associated with the ambient IOT devices 310), and may obtain measurements (e.g., signal strength measurements, such as RSSI) of the received beacon frames. In response to receiving the beacon frames, the receivers may not perform an interrogation itself, but rather may relay the information within and/or associated with (e.g., measurements, such as the RSSI) the beacon frames to the ERP system (e.g., network entity 450, such as an ERP server), for example via the network device 330 (e.g., access point) and the network entity 340 (e.g., an edge server).

In some examples, the ERP system (e.g., network entity 450, such as an ERP server), the network device 330 (e.g., access point) and/or the network entity 340 (e.g., an edge server) may determine (e.g., compute) a position (e.g., an estimated location) for an ambient IOT device 310 based on signal strengths (e.g., RSSIs) measured by a plurality of wireless communication devices 360 (e.g., ESLs) of signals (e.g., beacons) transmitted from that ambient IOT device 310.

For example, for a given ambient IOT device 310, let r₁≥r₂≥ . . . r_{M} denote the RSSI values for M number of wireless communication devices 360 (e.g., ESLs) in descending order. The position estimate for the ambient IOT device 310 can then be given by the weighted average of the known positions of the wireless communication devices 360 (e.g., ESLs), where the weights may be a function of the RSSI values. As such, the position for the ambient IOT device 310 may be determined by using the following equations:

$$\hat{P} = \frac{{\sum }_{k = 1}^{N} {w}_{k} \cdot {P}_{k}}{{\sum }_{k = 1}^{N} {w}_{k}} \qquad [ equation 1 ]$$

where N is the number of wireless communication devices 360 (e.g., ESLs), wₖ are the weights for the wireless communication devices 360 (e.g., ESLs), and Pₖ are the known positions (e.g., ground truth locations) for the wireless communication devices 360 (e.g., ESLs). The weights wₖ can be set to any suitable value. N is a subset of M. N may be an empirical term, which may be preset to some desired value.

As previously mentioned, in ESL systems, PAs are often utilized to provide regular and predictable payload transmissions from a central device (e.g., which may be in the form of a network device, such as an access point) to one or more peripheral devices (e.g., which may each be in the form of a wireless communication device, such as an ESL). PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) was introduced to ESL systems to provide bidirectionality (e.g., bidirectional transmissions between a central device and one or more peripheral devices). Peripheral devices synchronized within a group of peripheral devices can be addressed by a central device on a synchronized channel (e.g., a synchronized frequency channel between the central device and the peripheral devices) whenever the central device determines to send (e.g., transmit) a request (e.g., a PA containing a synchronization message transmitted on the synchronized channel) to the peripheral devices. If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

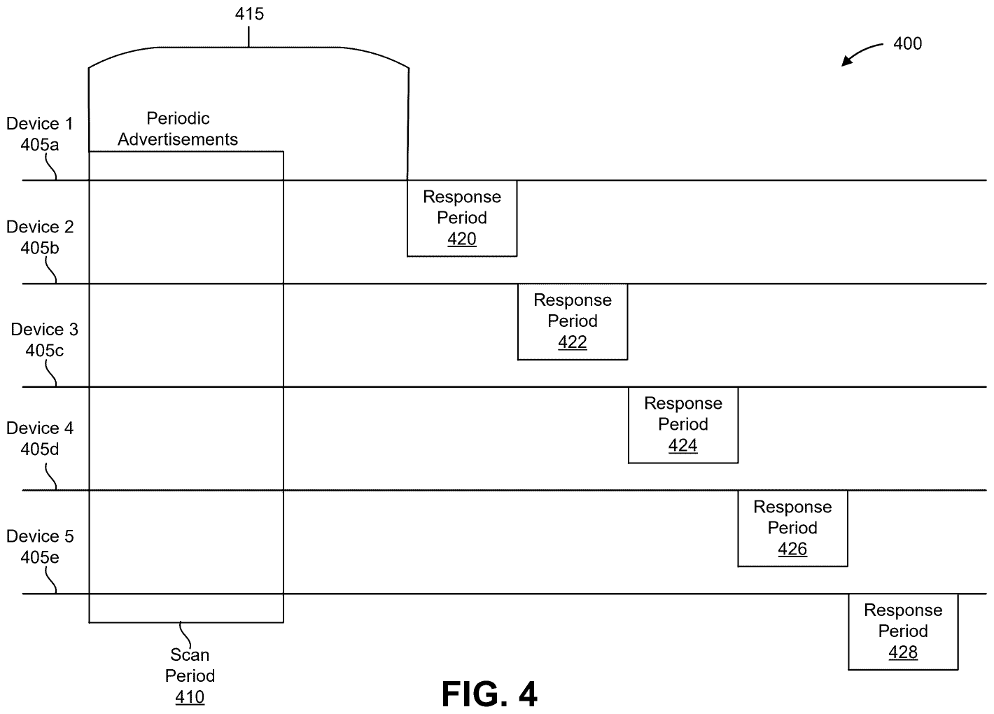

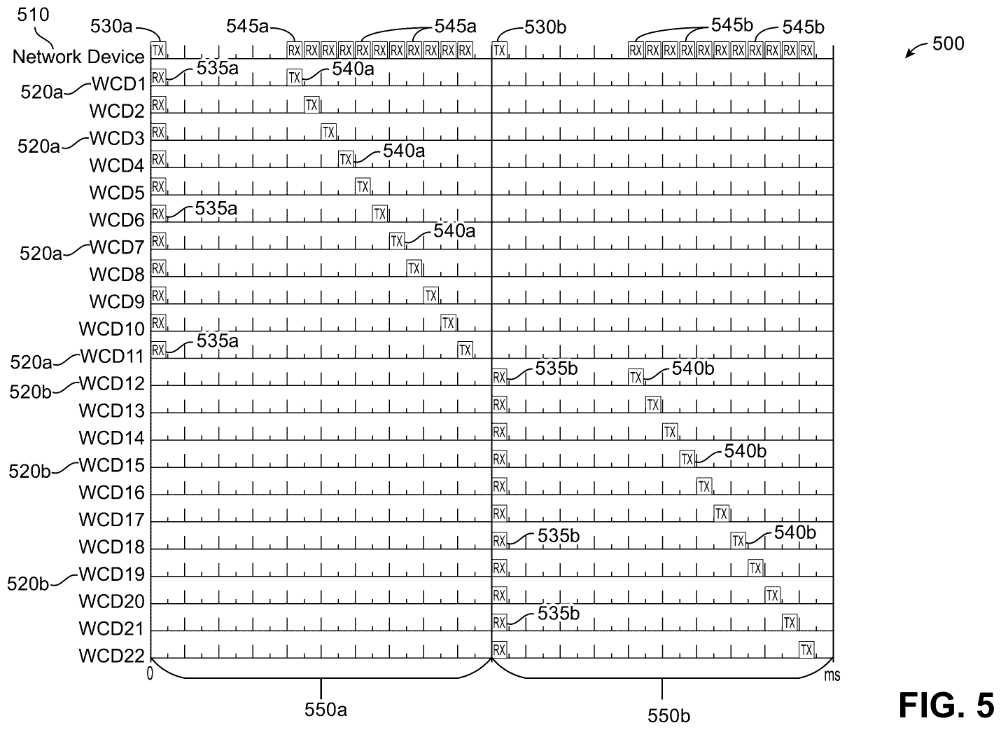

FIGS. 4 and 5 show signaling diagrams illustrating examples of PAwR in an ESL system. In particular, the signaling diagram of FIG. 4 shows an example PAwR for a group of wireless network devices (e.g., device 1 405a, device 2 405b, device 3 405c, device 4 405d, and device 5 405e), and the signaling diagram of FIG. 5 shows an example PAwR for two groups of wireless network devices 520a, 520b (e.g., a first group including ESL1 to ESL 11, and a second group including ESL 12 to ESL 22). Specifically, FIG. 4 is a signal timing diagram illustrating a portion of a communication between an access point (e.g., access point 110) and wireless communication devices 120 (e.g., ESLs). With reference to FIG. 1, the signal sequence illustrated in FIG. 4 may be implemented by one or more of the communication connections, access points 110, and/or wireless communication devices 120 of FIG. 1.

The devices (e.g., device 1 405a, device 2 405b, device 3 405c, device 4 405d, and device 5 405e) of FIG. 4 may be selected from wireless communication devices 120 of FIG. 1, and may each receive a periodic advertisement (PA) in a scan period 410. The scan period 410 may occur in regularly scheduled intervals and may be repeated periodically such that the devices (e.g., device 1 405a, device 2 405b, device 3 405c, device 4 405d, and device 5 405e) can awaken to scan for messages during this repeated scan period 410. An access point (e.g., access point 110 of FIG. 1) may provide periodic advertisements (PAs) via broadcast or multi-cast to the devices (e.g., device 1 405a, device 2 405b, device 3 405c, device 4 405d, and device 5 405e) in the scan period 410. For an access point (e.g., access point 110 of FIG. 1), the scan period 410 can be its primary transmission period. In some cases, the scan period 410 may not be a fixed time because the access point (e.g., access point 110 of FIG. 1) may send different lengths of data from the start of the scan period 410.

The transmission may include multiple advertisements in a train. One or more portions of the advertisements may be directed to one or more of the devices (e.g., device 1 405a, device 2 405b, device 3 405c, device 4 405d, and device 5 405e). The devices (e.g., device 1 405a, device 2 405b, device 3 405c, device 4 405d, and device 5 405e) may decode or filter the messages intended for each specific device and transmitted during the period when all devices are receiving. In this way, the devices (e.g., device 1 405a, device 2 405b, device 3 405c, device 4 405d, and device 5 405e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 405a, device 2 405b, device 3 405c, device 4 405d, and device 5 405e).

As illustrated, the devices (e.g., device 1 405a, device 2 405b, device 3 405c, device 4 405d, and device 5 405e) are each assigned a response period 420, 422, 424, 426, 428 in the time after the scan period 410. The response periods 420, 422, 424, 426, 428 for the ESL transmissions occur in a time division multiple access (TDMA) manner. In some cases, the assignment of the response period to a particular device may not be permanent. In some aspects, the assignment may be inferred from a payload of a synchronization message. The first response period 420 may begin following an idle time 415 after the scan period 410, with the idle period being long enough to provide the transmitter device an opportunity to do other Bluetooth related activities. The assigned response periods may also be limited to or designate a particular frequency of the channels on which to respond. For example, in FIG. 4, device 1 405a is assigned response period 420, device 2 405b is assigned response period 422, device 3 405c is assigned response period 424, device 4 405d is assigned response period 426, and device 5 405e is assigned response period 428. The access point (e.g., access point 110 of FIG. 1) may store attributes of the devices (e.g., device 1 405a, device 2 405b, device 3 405c, device 4 405d, and device 5 405e), including whether a device is able to transmit or respond. The PA signaling followed by responses can be referred to as periodic advertisement with multiple responses (PAwMR).

For example, device 3 405c (e.g., wireless communication device 120 of FIG. 1) may be an ESL and may receive a price update in a PA from the access point (e.g., access point 110 of FIG. 1) in scan period 410. The PA received at device 3 405c may include a designated start time for the response period 424 or may include a schedule of response start times for devices including device 3 405c. The response by device 3 405c to the access point (e.g., access point 110 of FIG. 1) may include an acknowledgement, a status code, and/or other information such as battery life, received signal strength, and/or an error notification. The response by device 3 405c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 405a, device 2 405b, device 3 405c, device 4 405d, and device 5 405e) may use channels of the Bluetooth protocol.

A device (e.g., device 5 405e) that has been assigned a response period may not respond and may determine that it has nothing to signal. In other words, the devices (e.g., device 1 405a, device 2 405b, device 3 405c, device 4 405d, and device 5 405e) may determine what response, if any, is required and may or may not respond to a request sent from the access point (e.g., access point 110 of FIG. 1). The response periods 420, 422, 424, 426, 428 may be assigned based on a request for such a period in an open transmission time, the request being sent to the access point (e.g., access point 110 of FIG. 1). The response periods 420, 422, 424, 426, 428 may be assigned based on which devices have been requested by the access point (e.g., access point 110 of FIG. 1) to send data or acknowledgements. The PA messages and responses may be frequency-hopped, time synchronized channels, and/or extended channels of the advertisement channels in Bluetooth.

As previously mentioned, FIG. 5 shows an example PAwR for two groups of wireless network devices 520a, 520b (e.g., a first group including ESL1 to ESL 11, and a second group including ESL 12 to ESL 22). In particular, FIG. 5 is a signaling diagram illustrating an example of communication transmissions 500 between a network device 510 (e.g., a central device, which may be an access point) and two groups of wireless communication devices 520a, 520b (e.g., peripheral devices, which may be ESLs). With reference to FIG. 1, the signal sequence illustrated in FIG. 5 may be implemented by one or more of the communication connections, access points 110, and/or wireless communication devices 120 of FIG. 1.

In FIG. 5, the signaling diagram is shown in the form of a graph (e.g., a time grid, which may be predetermined) with an x-axis denoting time in milliseconds (ms) and a y-axis denoting specific wireless communication devices 520a, 520b (e.g., ESL1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). In particular, the x-axis of the graph of FIG. 5 denotes time starting from zero (0) ms. The time can be divided into two subframes 550a, 550b. As such, the two subframes 550a, 550b may include a first subframe 550a and a second subframe 550b. In one or more examples, there may be more or less than two subframes 550a, 550b as is shown in FIG. 5, and/or each subframe 550a, 550b may be longer or shorter than as shown in FIG. 5.

In one or more examples, the wireless communication devices 520a, 520b (e.g., peripheral devices) may be assigned (e.g., by the network device 510 and/or by a network entity, such as a management entity) to different groups (e.g., two groups) of wireless communication devices 520a, 520b. For example, wireless communication devices 520a (e.g., ESL1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 520b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 5, during operation for PAwR, at time 0 ms for the first subframe 550a of time, the network device 510 (e.g., a central, such as an AP) may transmit 530a to a first group (e.g., group 1) of wireless communication devices 520a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 510 and the wireless communication devices 520a, 520b. As noted previously, a synchronization message can include one or more commands. For instance, a command can include an operational code (OpCode) and parameters associated with the command. At time 0 ms, the first group of wireless communication devices 520a (e.g., ESL 1, ESL 2, ESL 3, ESL 4, ESL 5, ESL 6, ESL 7, ESL 8, ESL 9, ESL 10, and ESL 11) can receive 535a the PA containing the synchronization message over the synchronized channel.

In one or more examples, the network device 510 may be configured to transmit PAs at a specified time interval (e.g., a subframe of time), such as is shown in FIG. 5. In one or more examples, the specified time interval (e.g., a subframe) may be shorter or longer than the as is shown in FIG. 5. The wireless communication devices 520a, 520b may respond to a PA by using their specific respective response slot in time.

In one or more examples, the synchronization message transmitted 530a to the first group (e.g., group 1) of wireless communication devices 520a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 520a (e.g., ESL 1, ESL 2, ESL 3, ESL 4, ESL 5, ESL 6, ESL 7, ESL 8, ESL 9, ESL 10, and/or ESL 11) in the first group to use to transmit 540a a response to the network device 510. If a wireless communication device 520a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 520a (e.g., ESL 1, ESL 2, ESL 3, ESL 4, ESL 5, ESL 6, ESL 7, ESL 8, ESL 9, ESL 10, and ESL 11) can respond (e.g., transmit 540a) in its respective response slot, as indicated within the synchronization message. For example, the synchronization message may indicate a specific sequence for one or more of the wireless communication devices 520a (e.g., ESL 1, ESL 2, ESL 3, ESL 4, ESL 5, ESL 6, ESL 7, ESL 8, ESL 9, ESL 10, and/or ESL 11) to respond (e.g., transmit 540a) in time (e.g., responding after 5 ms has elapsed after the start of the subframe 550a at response slots as shown in FIG. 5).

After the wireless communication devices 520a (e.g., ESL 1, ESL 2, ESL 3, ESL 4, ESL 5, ESL 6, ESL 7, ESL 8, ESL 9, ESL 10, and ESL 11) have received 535a the PA containing the synchronization message from the network device 510, according to the sequence specified within the synchronization message, the one or more wireless communication devices 520a (e.g., ESL 1, ESL 2, ESL 3, ESL 4, ESL 5, ESL 6, ESL 7, ESL 8, ESL 9, ESL 10, and/or ESL 11) can transmit 540a their responses within their respective response slots. After the one or more wireless communication devices 520a (e.g., ESL 1, ESL 2, ESL 3, ESL 4, ESL 5, ESL 6, ESL 7, ESL 8, ESL 9, ESL 10, and/or ESL 11) have transmitted 540a their responses in their respective response time slots, the network device 510 can receive 545a their transmitted responses at those specific response slot times.

During operation for PAwR, for the second subframe 550b of time, the network device 510 may transmit 530b to a second group (e.g., group 2) of wireless communication devices 520b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 510 and the wireless communication devices 520a, 520b. In addition, at the start of the second subframe 550b, the second group of wireless communication devices 520b (e.g., ESL 12, ESL 13, ESL 14, ESL 15, ESL 16, ESL 17, ESL 18, ESL 19, ESL 20, ESL 21, and ESL 22) can receive 535b the PA containing the synchronization message over the synchronized channel.

The synchronization message transmitted 530b to the second group (e.g., group 2) of wireless communication devices 520b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 520b (e.g., ESL 12, ESL 13, ESL 14, ESL 15, ESL 16, ESL 17, ESL 18, ESL 19, ESL 20, ESL 21, and/or ESL 22) in the second group to use to transmit 540b a response to the network device 510. If a wireless communication device 520b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 520b (e.g., ESL 12, ESL 13, ESL 14, ESL 15, ESL 16, ESL 17, ESL 18, ESL 19, ESL 20, ESL 21, and ESL 22) can respond (e.g., transmit 540b) in its respective response slot, as indicated within the synchronization message. For example, the synchronization message may indicate a specific sequence for one or more of the wireless communication devices 520b (e.g., ESL 12, ESL 13, ESL 14, ESL 15, ESL 16, ESL 17, ESL 18, ESL 19, ESL 20, ESL 21, and/or ESL 22) to respond (e.g., transmit 540b) in time (e.g., responding after 5 ms has elapsed after the start of the subframe at response slots as shown in FIG. 5).

After the wireless communication devices 520b (e.g., ESL 12, ESL 13, ESL 14, ESL 15, ESL 16, ESL 17, ESL 18, ESL 19, ESL 20, ESL 21, and ESL 22) have received 535b the PA containing the synchronization message from the network device 510, according to the sequence specified within the synchronization message, the one or more wireless communication devices 520b (e.g., ESL 12, ESL 13, ESL 14, ESL 15, ESL 16, ESL 17, ESL 18, ESL 19, ESL 20, ESL 21, and/or ESL 22) may transmit 540b their responses within their respective response slots. After the one or more wireless communication devices 520b (e.g., ESL 12, ESL 13, ESL 14, ESL 15, ESL 16, ESL 17, ESL 18, ESL 19, ESL 20, ESL 21, and/or ESL 22) have transmitted 540b their responses in their respective response time slots, the network device 510 can receive 545b their transmitted responses at those specific response slot times. The PAwR may continue similarly for subsequent subframes of time.

As previously mentioned, typically, the ambient IOT devices are transmit-only devices, whose transmissions may not be deterministically scheduled (e.g., to avoid interference). The ambient IOT devices continuously transmit beacons causing the wireless communication devices (e.g., ESLs) to keep waking up to receive the beacons. The wireless communication devices (e.g., ESLs) need to be activated/woken up in a strategic manner to receive multiple tag transmissions without draining their battery resources (e.g., ESLs are generally battery powered and, as such, power constrained). As such, timing synchronization is needed between the network devices (e.g., access points), wireless communication devices (e.g., ESLs), energizing devices, and ambient IOT devices (e.g., ambient IOT tags).

Therefore, improved systems and techniques (e.g., along with associated message flows) that can achieve an accurate (e.g., tight) synchronization between the network devices (e.g., access points), wireless communication devices (e.g., ESLs), energizing devices, and ambient IOT devices (e.g., ambient IOT tags) can be useful. Systems and techniques that provide coarse position estimates for the ambient IOT devices to ensure an even more accurate (e.g., tighter) synchronization between the ambient IOT devices and the intended destination wireless communication devices (e.g., ESLs) can also be beneficial.

In one or more aspects, as noted previously, the systems and techniques provide solutions for establishing timing synchronization for computing devices. In some cases, for instance, the systems and techniques can provide synchronization for position estimation of transmit-only ambient IOT tags (e.g., in smart retail, for smart warehousing solutions, for automotive applications, among other use cases). Some aspects relate to systems and techniques that provide an accurate (e.g., tight) synchronization between network devices (e.g., access points), wireless communication devices (e.g., ESLs), energizing devices (e.g., energizers), and ambient IOT devices (e.g., ambient IOT tags). In one or more aspects, an energizing device (e.g., an energizer) may synchronize its timing with a network device (e.g., an access point) via a wired connection, or via beacons transmitted wirelessly from the network device (e.g., the access point) or from wireless communication devices (e.g., ESLs) associated with the network device (e.g., the access point). When there are multiple network devices (e.g., access points) detected by an energizing device, a network device (e.g., access point) may be selected for synchronization, based on the strongest signal strength (e.g., RSSI) from the network device (e.g., access point) and/or based on strong signal strengths from a subset of wireless communication devices (e.g., ESLs) such that the network device (e.g., access point) associated with the subset of wireless communication devices can be selected. In some aspects, an ambient IOT device (e.g., an ambient IOT tag) may send (e.g., transmit) its beacon within an ESL receive time window, where the beacon transmission can occur at the end of an energizer transmission or at an ON/OFF pattern in a waveform of an energizer transmission. In one or more examples, based on a coarse location of an ambient IOT device(s), a corresponding network device (e.g., access point) can increase the synchronization accuracy of wireless communication devices (e.g., ESLs) by increasing its frequency of beacon transmissions and/or by indicating to a subset of wireless communication devices (e.g., ESLs) located within the vicinity of the estimated coarse location(s) of the ambient IOT device(s) to wake up to receive transmissions more frequently.

In one or more examples, during operation of the systems and techniques for synchronization, an energizing device (e.g., an energizer) may synchronize with a network device (e.g., an access point) of a plurality of network devices (e.g., access points), based on received timing information transmitted from a network entity (e.g., an edge server) over a wired connection, based on received signal strengths (e.g., RSSIs) of beacons transmitted from the plurality of network devices, and/or based on received signal strengths (e.g., RSSIs) of beacons from a plurality of wireless communication devices (e.g., ESLs) associated with the plurality of network devices. In one or more examples, the timing information can be associated with the network device (e.g., access point). In some examples, the signal strength (e.g., RSSI) of the beacon transmitted from the network device of the plurality of network devices is greater than the signal strengths of the beacons transmitted from other network devices of the plurality of network devices. In one or more examples, a subset of the wireless communication devices of the plurality of wireless communication devices may be associated with the network device. In some examples, the signal strengths (e.g., RSSIs) of the beacons transmitted from the subset of wireless communication devices of the plurality of wireless communication devices are greater than the signal strengths of the beacons transmitted from other wireless communication devices of the plurality of wireless communication devices. In one or more examples, each beacon of the beacons transmitted by the plurality of wireless communication devices may include an identification of an associated network device of the plurality of network devices. The energizing device may transmit, to an ambient device (e.g., an ambient IOT device or tag), an energizer transmission indicating timing for synchronization of the ambient device to the energizing device. In one or more examples, an end of the energizer transmission may indicate a boundary between time slots of a time grid associated with the timing for the synchronization of the computing device to the energizing device. In some examples, the energizer transmission may include a waveform with a pattern indicating a boundary between time slots of the time grid.

In some examples, during operation of the systems and techniques for synchronization, a network device (e.g., an access point) may determine a position for an ambient device (e.g., an ambient IOT device or tag) based on signal strengths (e.g., RSSIs) measured by a plurality of wireless communication devices (e.g., ESLs) of signals transmitted from the ambient device. The network device may increase a synchronization accuracy of the plurality of wireless communication devices with the network device and the ambient device based on increasing a frequency of transmission of beacons by the network device, and/or based on indicating to a subset of wireless communication devices of the plurality of wireless communication devices located in proximity (e.g., located nearby) to the position for the ambient device to wake up to receive transmissions more frequently than scheduled according to a predetermined time grid.

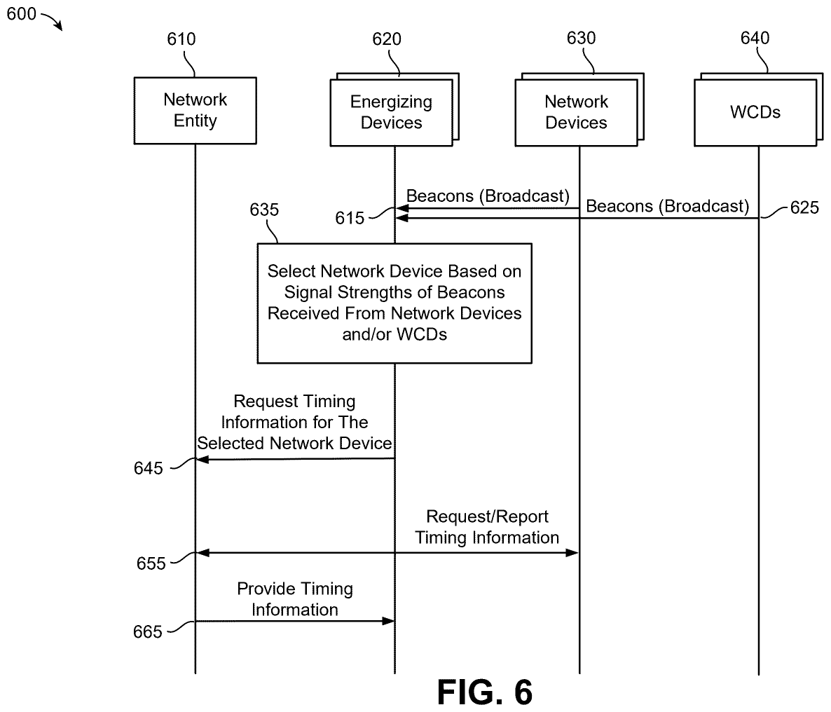

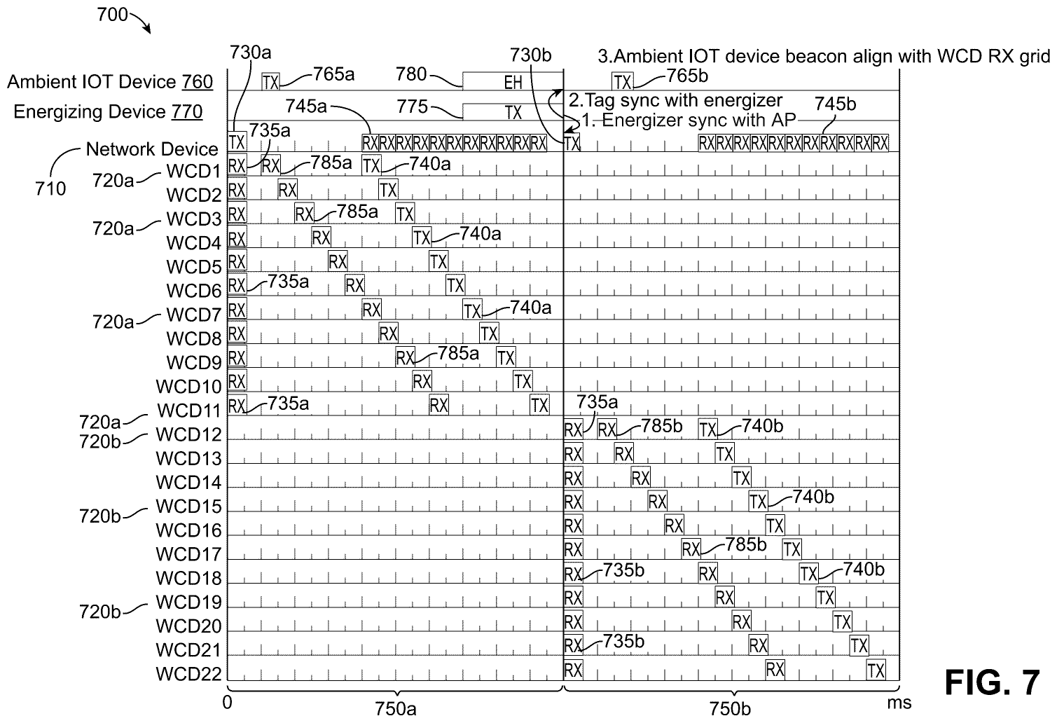

FIGS. 6 and 7 show signaling diagrams showing examples of signaling for synchronization for computing devices. In particular, FIG. 6 is a signaling diagram illustrating an example of communication transmissions 600 for synchronization between network devices 630 (e.g., access points) and energizing devices 620 (e.g., energizers). In FIG. 6, a network entity 610 (e.g., an edge server), a plurality of energizing devices 620 (e.g., energizers), a plurality of network devices 630 (e.g., access points), and a plurality of wireless communication devices (WDCs) 640 (e.g., ESLs) are shown.

The energizing devices 620 can each synchronize with one of the network devices 630 (e.g., access points). In one or more examples, when a wired connection exists between the network entity 610 (e.g., edge server), the network devices 630 (e.g., access points), and the energizing devices 620; the network entity 610 (e.g., edge server) can provide (e.g., transmit) to an energizing device 620 timing information for a given network device 630 (e.g., access point). The energizing device 620 can receive this timing information (e.g., associated with the given network device 630) and can synchronize to the network device 630 (e.g., access point) based on the received timing information transmitted from the network entity 610 (e.g., edge server) over the wired connection.

In one or more examples, when a wired connection does not exist, the communication transmissions 600 of FIG. 6 can be employed for the energizing devices 620 to each synchronize with one of the network devices 630 (e.g., access points). During operation of the communication transmissions 600 of FIG. 6, the plurality of network devices 630 (e.g., access points) and the plurality of WCDs 640 (e.g., ESLs) are shown to transmit (e.g., broadcast) beacons (at operation 615 and operation 625) to the energizing devices 620. The energizing devices 620 can receive the beacons.

At operation 635, the energizing devices 620 can each select a network device 630 (e.g., access point) to synchronize with, based on received signal strengths (e.g., RSSIs) of the beacons transmitted (at operation 615 and operation 625) from the plurality network devices 630 (e.g., access points) or from the plurality of WCDs 640 (e.g., ESLs) associated with the plurality of network devices 630 (e.g., access points). In one or more examples, an energizing device 620 can select a network device 630 to synchronize with that transmits a beacon having a greater signal strength than the beacons transmitted by the other network devices 630.

In some examples, at operation 635, an energizing device 620 can select a network device 630 to synchronize with, where a subset of the WCDs 640 of the plurality of WCDs 640 may be associated with the network device 630, and the signal strengths (e.g., RSSIs) of the beacons transmitted from the subset of WCDs 640 of the plurality of WDCs 640 are greater than the signal strengths of the beacons transmitted from other WDCs 640 of the plurality of WDCs 640. In one or more examples, each beacon of the beacons transmitted by the plurality of WDCs 640 may include an identification (ID), such as a medium access control (MAC) address, of an associated network device 630 of the plurality of network devices 630 (e.g., a network device 630 that the WDCs 640 are currently synchronized).

After each energizing device 620 selects a network device 630 to synchronize with, the energizing devices 620 can transmit (at operation 645) to the network entity 610 a request for timing information for their respective selected network device 630. After receiving the request for the timing information, the network entity 610 can transmit/receive (at operation 655) to/from the selected network device 630 a request/report of the timing information (e.g., required only if the selected network device 630 generates a timing reference, such as a time grid, on its own without relying on the network entity 610). The network entity 610 then transmits (at operation 665) the timing information for the selected network device 630 to the energizing devices 620. After the energizing devices 620 receive the timing information, each energizing device 620 can synchronize to the respective selected network device 630 based on the received timing information.

FIG. 7 is a signaling diagram illustrating an example of communication transmissions 700 for synchronization between wireless communication devices 720a, 720b (e.g., ESLs) and ambient IOT devices 760 (e.g., ambient IOT tags). The communication transmissions 700 of FIG. 7 is similar to the communication transmissions 500 of FIG. 5, except that the communication transmissions 700 of FIG. 7 additionally include tag transmissions 765a, 765b by the ambient IOT devices 760 (e.g., including tag 1).

In particular, FIG. 7 shows an example PAwR for two groups of wireless network devices 720a, 720b (e.g., a first group including ESL1 to ESL 11, and a second group including ESL 12 to ESL 22). FIG. 7 is a signaling diagram illustrating an example of communication transmissions 700 between a network device 710 (e.g., a central device, which may be an access point) and two groups of wireless communication devices (WCD) 720a, 720b (e.g., peripheral devices, which may be ESLs). With reference to FIG. 1, the signal sequence illustrated in FIG. 7 may be implemented by one or more of the communication connections, access points 110, and/or wireless communication devices 120 of FIG. 1.

In FIG. 7, the signaling diagram is shown in the form of a graph (e.g., a time grid, which may be predetermined) with an x-axis denoting time in milliseconds (ms) and a y-axis denoting specific wireless communication devices 720a, 720b (e.g., ESL1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). The time grid of FIG. 7 us associated with timing for the synchronization of a computing device (e.g., the ambient IOT device 760) to an energizing device 770. The x-axis of the graph (e.g., time grid) of FIG. 7 denotes time starting from zero (0) ms. The time can be divided into two subframes 750a, 750b. The two subframes 750a, 750b may include a first subframe 750a and a second subframe 750b. In one or more examples, there may be more or less than two subframes 750a, 750b as is shown in FIG. 7, and/or each subframe 750a, 750b may be longer or shorter than as shown in FIG. 7.

In one or more examples, the wireless communication devices 720a, 720b (e.g., peripheral devices) may be assigned (e.g., by the network device 710 and/or by a network entity, such as a management entity or an edge server) to different groups (e.g., two groups) of wireless communication devices 720a, 720b. For example, wireless communication devices 720a (e.g., ESL1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 720b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 7, during operation for PAwR, at time 0 ms for the first subframe 750a of time, the network device 710 (e.g., a central, such as an AP) can transmit 730a to a first group (e.g., group 1) of wireless communication devices 720a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 710 and the wireless communication devices 720a, 720b. As noted previously, a synchronization message can include one or more commands. For instance, a command can include an operational code (OpCode) and parameters associated with the command. At time 0 ms, the first group of wireless communication devices 720a (e.g., ESL 1, ESL 2, ESL 3, ESL 4, ESL 5, ESL 6, ESL 7, ESL 8, ESL 9, ESL 10, and ESL 11) can receive 735a the PA containing the synchronization message over the synchronized channel.

In one or more examples, the network device 710 may be configured to transmit PAs at a specified time interval (e.g., a subframe of time), such as is shown in FIG. 7. In one or more examples, the specified time interval (e.g., a subframe) may be shorter or longer than the as is shown in FIG. 7. The wireless communication devices 720a, 720b may respond to a PA by using their specific respective response slot in time.

In one or more examples, the synchronization message transmitted 730a to the first group (e.g., group 1) of wireless communication devices 720a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 720a (e.g., ESL 1, ESL 2, ESL 3, ESL 4, ESL 5, ESL 6, ESL 7, ESL 8, ESL 9, ESL 10, and/or ESL 11) in the first group to use to transmit 740a a response to the network device 710. If a wireless communication device 720a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 720a (e.g., ESL 1, ESL 2, ESL 3, ESL 4, ESL 5, ESL 6, ESL 7, ESL 8, ESL 9, ESL 10, and ESL 11) may respond (e.g., transmit 740a) in its respective response slot, as indicated within the synchronization message. For example, the synchronization message can indicate a specific sequence for one or more of the wireless communication devices 720a (e.g., ESL 1, ESL 2, ESL 3, ESL 4, ESL 5, ESL 6, ESL 7, ESL 8, ESL 9, ESL 10, and/or ESL 11) to respond (e.g., transmit 740a) in time (e.g., responding after 5 ms has elapsed after the start of the subframe 750a at response slots as shown in FIG. 7).

After the wireless communication devices 720a (e.g., ESL 1, ESL 2, ESL 3, ESL 4, ESL 5, ESL 6, ESL 7, ESL 8, ESL 9, ESL 10, and ESL 11) have received 735a the PA containing the synchronization message from the network device 710, according to the sequence specified within the synchronization message, the one or more wireless communication devices 720a (e.g., ESL 1, ESL 2, ESL 3, ESL 4, ESL 5, ESL 6, ESL 7, ESL 8, ESL 9, ESL 10, and/or ESL 11) may transmit 740a their responses within their respective response slots. After the one or more wireless communication devices 720a (e.g., ESL 1, ESL 2, ESL 3, ESL 4, ESL 5, ESL 6, ESL 7, ESL 8, ESL 9, ESL 10, and/or ESL 11) have transmitted 740a their responses in their respective response time slots, the network device 710 can receive 745a their transmitted responses at those specific response slot times.

During operation for PAwR, for the second subframe 750b of time, the network device 710 can transmit 730b to a second group (e.g., group 2) of wireless communication devices 720b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 710 and the wireless communication devices 720a, 720b. In addition, at the start of the second subframe 750b, the second group of wireless communication devices 720b (e.g., ESL 12, ESL 13, ESL 14, ESL 15, ESL 16, ESL 17, ESL 18, ESL 19, ESL 20, ESL 21, and ESL 22) may receive 735b the PA containing the synchronization message over the synchronized channel.

The synchronization message transmitted 730b to the second group (e.g., group 2) of wireless communication devices 720b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 720b (e.g., ESL 12, ESL 13, ESL 14, ESL 15, ESL 16, ESL 17, ESL 18, ESL 19, ESL 20, ESL 21, and/or ESL 22) in the second group to use to transmit 740b a response to the network device 710. If a wireless communication device 720b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 720b (e.g., ESL 12, ESL 13, ESL 14, ESL 15, ESL 16, ESL 17, ESL 18, ESL 19, ESL 20, ESL 21, and ESL 22) may respond (e.g., transmit 740b) in its respective response slot, as indicated within the synchronization message. For example, the synchronization message can indicate a specific sequence for one or more of the wireless communication devices 720b (e.g., ESL 12, ESL 13, ESL 14, ESL 15, ESL 16, ESL 17, ESL 18, ESL 19, ESL 20, ESL 21, and/or ESL 22) to respond (e.g., transmit 740b) in time (e.g., responding after 5 ms has elapsed after the start of the subframe at response slots as shown in FIG. 7).

After the wireless communication devices 720b (e.g., ESL 12, ESL 13, ESL 14, ESL 15, ESL 16, ESL 17, ESL 18, ESL 19, ESL 20, ESL 21, and ESL 22) have received 735b the PA containing the synchronization message from the network device 710, according to the sequence specified within the synchronization message, the one or more wireless communication devices 720b (e.g., ESL 12, ESL 13, ESL 14, ESL 15, ESL 16, ESL 17, ESL 18, ESL 19, ESL 20, ESL 21, and/or ESL 22) can transmit 740b their responses within their respective response slots. After the one or more wireless communication devices 720b (e.g., ESL 12, ESL 13, ESL 14, ESL 15, ESL 16, ESL 17, ESL 18, ESL 19, ESL 20, ESL 21, and/or ESL 22) have transmitted 740b their responses in their respective response time slots, the network device 710 may receive 745b their transmitted responses at those specific response slot times. The PAwR may continue similarly for subsequent subframes of time.

In one or more examples, the ambient IOT devices 760 may be synchronized with the wireless communication devices 720a, 720b (e.g., ESLs) such that the ambient IOT devices 760 can be configured to transmit 765a, 765b beacon frames at a specified time interval (e.g., a subframe of time) that may be received 785a, 785b by the wireless communication devices 720a, 720b, such as is shown in FIG. 7. In one or more examples, the ambient IOT devices 760 (e.g., including tag 1) may synchronize with an energizer transmission 775 transmitted by an energizing device 770 (e.g., an energizer). The synchronization between an ambient IOT device 760 (e.g., tag 1) and the energizing device 770 is implicit in a sense that the ambient IOT device 760 can simply establish a time reference after it is energized.

An ambient IOT device 760 needs to ensure that it transmits within a specific time window that aligns with the time grid that the wireless communication devices 720a, 720b (e.g., ESLs) are synchronized. In one or more examples, an energizer transmission 775 may indicate timing of a time grid for synchronization of the ambient IOT device 760 (e.g., tag 1) with the energizing device 770. For example, the energizing device 770 may transmit an energizer transmission 775. In one or more examples, an end of the energizer transmission 775 can indicate a boundary between time slots (e.g., a boundary between the first subframe 750a and the second subframe 750b) of the time grid. In some examples, a pattern (e.g., an ON/OFF pattern) of a waveform of the energizer transmission 775 can indicate a boundary between time slots (e.g., a boundary between the first subframe 750a and the second subframe 750b) of the time grid.

During the transmission of the energizer transmission 775, the ambient IOT device 760 (e.g., tag 1) can harvest energy from the energizer transmission 775 to energize itself. After the ambient IOT device 760 has harvested enough energy to be able to transmit, the ambient IOT device 760 can send (e.g., transmit) beacon frames based on the energizer transmission 775. For example, the ambient IOT device 760 can use the boundary indicated by the end of the energizer transmission 775 as a time reference for the timing of the time slots of the time grid. In one or more examples, the ambient IOT device 760 may transmit beacons right away (e.g., at the beginning of the second subframe 750b) or the ambient IOT device 760 may transmit 765b beacons after a delay in time, as is shown in FIG. 7.

The wireless communication devices 720a, 720b need to wake up with sufficient precision in order to receive the beacons transmitted by the ambient IOT devices 760. Based on a coarse position or location (e.g., proximity) (e.g., which may be determined by using equation 1) of the ambient IOT devices 760 (e.g., that were previously detected by one or more energizing devices 770), the corresponding network device 710 (e.g., access point) whose coverage area contains the estimated coarse location, to increase the synchronization accuracy, may be controlled to: increase a frequency of transmissions of beacons by the network device 710 (such that all the wireless communication devices 720a, 720b are synchronized more accurately), and/or indicate to a subset of wireless communication devices 720a, 720b located in proximity to the estimated coarse location to wake up to receive transmissions more frequently than scheduled according to the predetermined time grid.

In one or more examples, in the presence of many devices, interference may occur on the uplink. In some examples, the ambient IOT devices 760 may employ interference mitigation schemes. For example, an energizer transmission can be used to control the operation of the ambient IOT devices 760. However, these ambient IOT devices 760 are low-cost energy-harvesting tags that are incapable of demodulation and can perform only rudimentary processing.

In one or more examples, the presence or absence of a few tones within an energizer transmission can be used to indicate: one or more channels to be utilized by the ambient IOT devices 760 for transmission (e.g., in the case of multiple channels, a random one may be chosen), distinct subgroups of wireless communication devices (e.g., ESLs) that may be configured to listen to each of these channels, timing offsets (e.g., each a milliseconds duration) that may be randomly chosen by the ambient IOT devices 760 for transmission (e.g., which can also be interpreted as a random backoff factor).

The wireless communication device (e.g., ESL) operation may also be configured on the basis of an overcrowding/density of ambient IOT devices 760 within given area. The bubble size (e.g., number of ESLs that are awakened to operate in a receive mode) may be increased or decreased, as per the perceived density of the ambient IOT devices 760. Similarly, the listening rate may be increased (or decreased) accordingly. In the case of a higher number of interfering devices on the uplink, a larger bubble that is frequency awakened, is more likely to pick up more interference-free uplink transmissions, as the outlier (interfered) measurements can be rejected.

In one or more examples, in general, several tens or even hundreds of ambient IOT devices 760 may be energized at the same time and potentially transmit around the same time on the uplink. This would lead to significant interference at the receivers (e.g., such as the ESLs or access points). This interference may be mitigated through some level of scheduling and random access schemes. Ambient IOT devices 760 with poorer energizing coverage (and lower transmit power on the uplink) may be grouped together for transmission on the uplink such that stronger ambient IOT devices 760 do not interfere and subdue the weaker ones.

In some examples, given a set of ambient IOT devices 760, with a corresponding known transmit power value (inferred from their respective beacons on the uplink), the ambient IOT devices 760 may be grouped together in ranked order of the transmit power value. For instance, Group 1 may include ambient IOT devices 760 with a transmit power from 0 to −5 decibel-milliwatts (dBm), Group 2 with a transmit power from −5 to −10 dBm, and so on. A unique offset for each of the groups may be assigned, and additional smaller random offsets for the ambient IOT devices 760 within a group can be assigned. The offset may pertain to either a time offset and/or a channel (frequency) offset. Since the ambient IOT devices 760 are incapable of demodulation, information regarding offsets may be: pre-configured and stored in the ambient IOT devices 760 firmware for processing, or implicitly indicated by the presence/absence of some tones in the energizer transmission. An offset (for both timing and frequency) can be selected by the ambient IOT devices 760 for transmitting a beacon message.

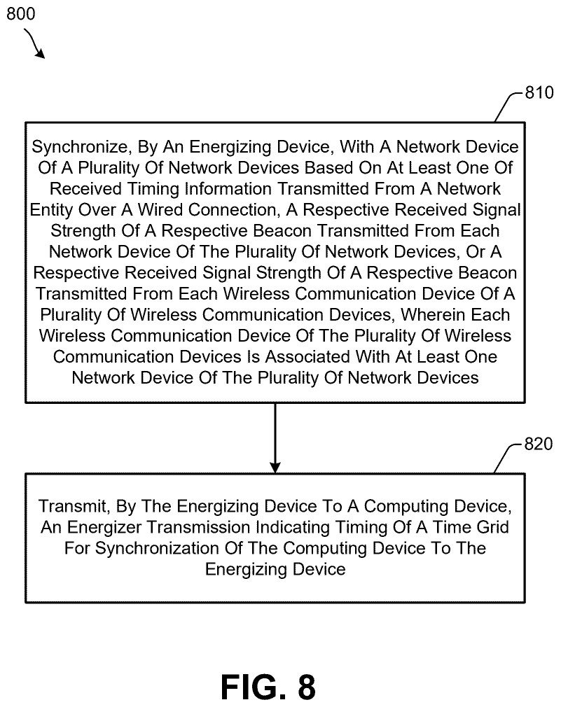

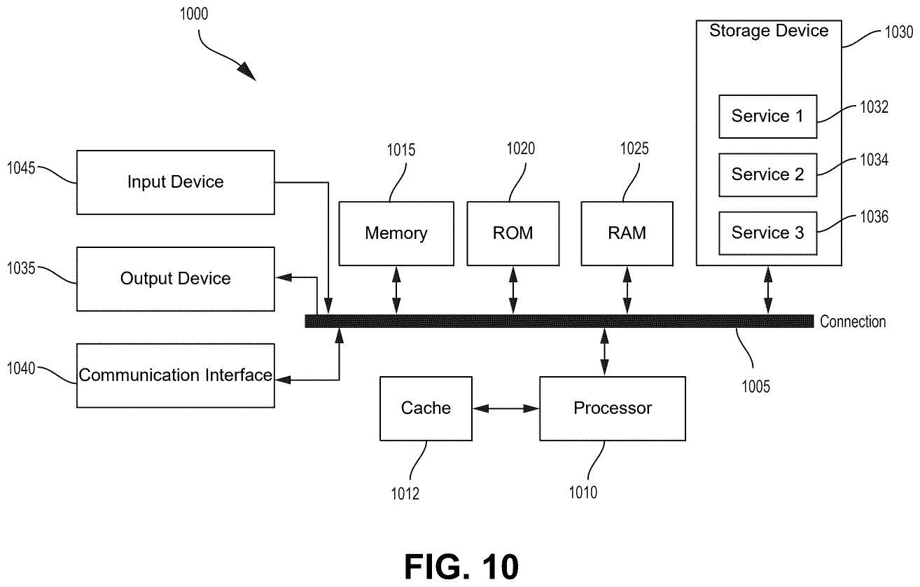

FIG. 8 is a flow chart illustrating an example of a process 800 for synchronization for computing devices (e.g., for position estimation of transmit-only ambient IOT tags). The process 800 can be performed by an energizing device (e.g., energizing device 320 of FIG. 3, energizing devices 620 of FIG. 6, energizing device 770 of FIG. 7, or other energizing device) or by a component or system (e.g., a chipset, one or more processors such as one or more central processing units (CPUs), digital signal processors (DSPs), graphics processing units (GPUs), any combination thereof, and/or other type of processor(s), or other component or system) of the energizing device. In some cases, the energizing device can include the computing system 1000 of FIG. 10. The operations of the process 800 may be implemented as software components that are executed and run on one or more processors (e.g., processor 1010 of FIG. 10 or other processor(s)). Further, the transmission and reception of signals by the computing device in the process 800 may be enabled, for example, by one or more antennas and/or one or more transceivers (e.g., wireless transceiver(s)).

At block 810, the energizing device (or component thereof, such a processor or multiple processors) can synchronize with a network device (e.g., an AP) of a plurality of network devices (e.g., multiple APs or other network devices) based on received timing information transmitted from a network entity (e.g., a server, such as an edge server, or other type of network entity) over a wired connection, a respective received signal strength (e.g., a received signal strength indicator (RSSI)) of a respective beacon transmitted from each network device of the plurality of network devices (e.g., an RSSI of a first beacon transmitted from a first network device, an RSSI of a second beacon transmitted from a second network device, etc.), a respective received signal strength (e.g., RSSI) of a respective beacon transmitted from each wireless communication device of a plurality of wireless communication devices (e.g., an RSSI of a first beacon transmitted from a first wireless communication device, an RSSI of a second beacon transmitted from a second wireless communication device, etc.). Each wireless communication device of the plurality of wireless communication devices is associated with at least one network device of the plurality of network devices, or any combination thereof. The wireless communication devices can include peripheral devices (e.g., electronic shelf labels (ESLs) etc.) or other type of wireless communication devices.

For instance, as described with respect to FIG. 6, the energizing devices 620 can each select (at operation 635) a network device 630 to synchronize with, based on received signal strengths (e.g., RSSIs) of the beacons transmitted (at operation 615 and operation 625) from the plurality network devices 630 or from the plurality of WCDs 640 associated with the plurality of network devices 630. In one example, according to some aspects, the energizing device (or component thereof) can synchronize with the network device of the plurality of network devices based on a signal strength of a beacon transmitted from the network device being greater than signal strengths of beacons transmitted from other network devices of the plurality of network devices. Referring to FIG. 6 as an illustrative example, the energizing device 620 can select a network device 630 to synchronize with that transmits a beacon having a greater signal strength than the beacons transmitted by the other network devices 630.

In another example, according to some aspects, a subset of wireless communication devices of the plurality of wireless communication devices are associated with the network device. In such aspects, the energizing device (or component thereof) can synchronize with the network device of the plurality of network devices based on received signal strengths of beacons transmitted from the subset of wireless communication devices of the plurality of wireless communication devices being greater than signal strengths of beacons transmitted from other wireless communication devices of the plurality of wireless communication devices. Referring to FIG. 6 as an illustrative example, the energizing device 620 can select (at operation 635) a network device 630 to synchronize with, where the signal strengths (e.g., RSSIs) of beacons transmitted from a subset of the WCDs 640 of the plurality of WCDs 640 associated with the network device 630 are greater than the signal strengths of the beacons transmitted from other WDCs 640 of the plurality of WDCs 640 (that are not associated with the network device 63).

In some cases, each respective beacon transmitted by each wireless communication device of the plurality of wireless communication devices includes a respective identification (ID) (e.g., a MAC address) of an associated network device of the plurality of network devices. For example, referring again to FIG. 6 for illustrative purposes, each beacon of the beacons transmitted by the plurality of WDCs 640 may include an ID (e.g., a MAC address) of an associated network device 630 of the plurality of network devices 630 (e.g., a network device 630 with which the WDCs 640 are currently synchronized).

In some cases, the timing information is associated with the network device. For instance, referring to FIG. 6 as an illustrative example, the network entity 610 can transmit (at operation 665) timing information for the selected network device 630 to the energizing devices 620. After the energizing devices 620 receive the timing information, each energizing device 620 can synchronize to the respective selected network device 630 based on the received timing information.

At block 820, the energizing device (or component thereof, such a transceiver) can transmit (or output for transmission) to a computing device (e.g., an internet of things (IOT) device, such as an ambient IOT device, or other type of computing device), an energizer transmission indicating timing (e.g., of a time grid) for synchronization of the computing device to the energizing device. In some aspects, an end of the energizer transmission indicates a boundary between time slots of a time grid associated with the timing for the synchronization of the computing device to the energizing device. For instance, referring to FIG. 7 as an illustrative example, an end of the energizer transmission 775 can indicate a boundary between time slots (e.g., a boundary between the first subframe 750a and the second subframe 750b) of the time grid shown in FIG. 7. In some cases, the energizer transmission includes a waveform with a pattern indicating a boundary between time slots of the time grid. For instance, again referring to FIG. 7 for illustrative purposes, a pattern (e.g., an ON/OFF pattern) of a waveform of the energizer transmission 775 can indicate a boundary between time slots (e.g., a boundary between the first subframe 750a and the second subframe 750b) of the time grid.

During the transmission of the energizer transmission (e.g., the energizer transmission 775 of FIG. 7), the computing device (and any other computing devices, such as ambient IOT devices 760 of FIG. 7) can harvest energy from the energizer transmission to energize itself. After the computing device (e.g., ambient IOT device 760) has harvested enough energy to be able to transmit, the computing device can send (e.g., transmit) beacon frames based on the energizer transmission. For example, the computing device can use the boundary indicated by the end of the energizer transmission as a time reference for the timing of the time slots of the time grid. In some cases, the computing device can transmit beacons at the boundary (e.g., the ambient IOT device 760 can transmit beacons at the beginning of the second subframe 750b). In other cases, the computing device can transmit beacons after a delay in time (e.g., the ambient IOT device 760 can transmit 765b beacons after the delay in time shown in FIG. 7).

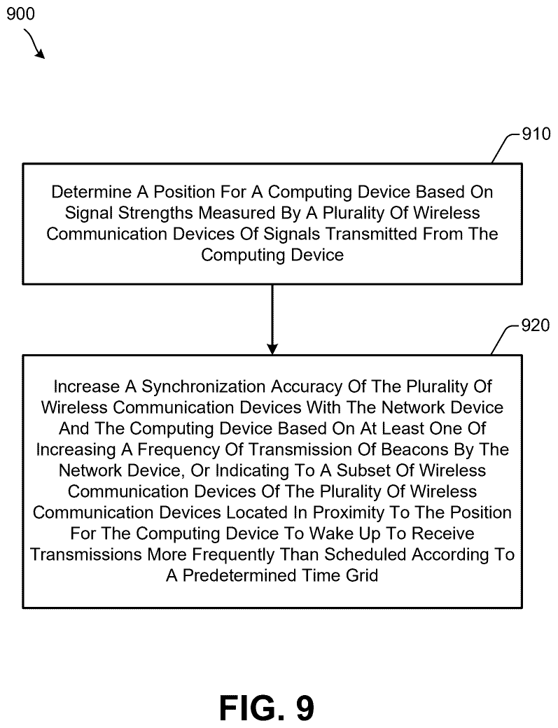

FIG. 9 is a flow chart illustrating an example of another process 900 for synchronization for computing devices (e.g., for position estimation of transmit-only ambient IOT tags). The process 900 can be performed by a network device (e.g., an access point, such as access point 110 of FIG. 1, device 200 of FIG. 2, network device 330 of FIG. 3, network device 510 of FIG. 5, network devices 630 of FIG. 6, network device 710 of FIG. 7, or a computing device or computing system 1000 of FIG. 10) or by a component or system (e.g., a chipset, one or more processors such as one or more central processing units (CPUs), digital signal processors (DSPs), graphics processing units (GPUs), any combination thereof, and/or other type of processor(s), or other component or system) of the network device. In some cases, the network device can include the computing system 1000 of FIG. 10. The operations of the process 900 may be implemented as software components that are executed and run on one or more processors (e.g., processor 1010 of FIG. 10 or other processor(s)). Further, the transmission and reception of signals by the computing device in the process 900 may be enabled, for example, by one or more antennas and/or one or more transceivers (e.g., wireless transceiver(s)).

At block 910, the network device (or component thereof) can determine a position for a computing device based on signal strengths measured by a plurality of wireless communication devices of signals transmitted from the computing device. In some cases, the computing device is an IOT device, such as an ambient IOT device. In some aspects, the wireless communication devices are peripheral devices, such as ESLs.

At block 920, the network device (or component thereof) can increase a synchronization accuracy of the plurality of wireless communication devices with the network device and the computing device based on increasing a frequency of transmission of beacons by the network device and/or based on indicating to a subset of wireless communication devices of the plurality of wireless communication devices located in proximity to the position for the computing device to wake up to receive transmissions more frequently than scheduled according to a predetermined time grid. For instance, referring to FIG. 7 as an illustrative example, based on a coarse position (e.g., determined by using equation 1) of the ambient IOT devices 760 (e.g., that were previously detected by one or more energizing devices 770), the corresponding network device 710 (e.g., access point) whose coverage area contains the estimated coarse location can increase the synchronization accuracy by increasing a frequency of transmissions of beacons by the network device 710 (such that all the wireless communication devices 720a, 720b are synchronized more accurately) and/or may indicate to a subset of wireless communication devices 720a, 720b located in proximity to the estimated coarse location to wake up to receive transmissions more frequently than scheduled according to the predetermined time grid.

In some cases, the computing device of process 800 and/or process 900 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 800 and/or process 900 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 and process 900 are illustrated as logical flow diagrams, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 800 and process 900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 10 is a block diagram illustrating an example of a computing system 1000, which may be employed for synchronization for computing devices. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LIDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An energizing device for wireless communication, the energizing device comprising: at least one memory; and at least one processor coupled to the at least one memory and configured to: synchronize with a network device of a plurality of network devices based on at least one of received timing information transmitted from a network entity over a wired connection, a respective received signal strength of a respective beacon transmitted from each network device of the plurality of network devices, or a respective received signal strength of a respective beacon transmitted from each wireless communication device of a plurality of wireless communication devices, wherein each wireless communication device of the plurality of wireless communication devices is associated with at least one network device of the plurality of network devices; and output, for transmission to a computing device, an energizer transmission indicating timing for synchronization of the computing device to the energizing device.

Aspect 2. The energizing device of Aspect 1, wherein the timing information is associated with the network device.

Aspect 3. The energizing device of any one of Aspects 1 or 2, wherein the at least one processor is configured to synchronize with the network device of the plurality of network devices based on a signal strength of a beacon transmitted from the network device being greater than signal strengths of beacons transmitted from other network devices of the plurality of network devices.

Aspect 4. The energizing device of any one of Aspects 1 to 3, wherein each respective signal strength of each respective beacon is a received signal strength indicator (RSSI).

Aspect 5. The energizing device of any one of Aspects 1 to 4, wherein a subset of wireless communication devices of the plurality of wireless communication devices are associated with the network device.

Aspect 6. The energizing device of Aspect 5, wherein the at least one processor is configured to synchronize with the network device of the plurality of network devices based on received signal strengths of beacons transmitted from the subset of wireless communication devices of the plurality of wireless communication devices being greater than signal strengths of beacons transmitted from other wireless communication devices of the plurality of wireless communication devices.

Aspect 7. The energizing device of any one of Aspects 1 to 6, wherein each respective beacon transmitted by each wireless communication device of the plurality of wireless communication devices comprises a respective identification (ID) of an associated network device of the plurality of network devices.

Aspect 8. The energizing device of any one of Aspects 1 to 7, wherein an end of the energizer transmission indicates a boundary between time slots of a time grid associated with the timing for the synchronization of the computing device to the energizing device.

Aspect 9. The energizing device of any one of Aspects 1 to 8, wherein the energizer transmission comprises a waveform with a pattern indicating a boundary between time slots of a time grid associated with the timing for the synchronization of the computing device to the energizing device.

Aspect 10. The energizing device of any one of Aspects 1 to 9, wherein each network device of the plurality of network devices is an access point (AP).

Aspect 11. The energizing device of any one of Aspects 1 to 10, wherein the network entity is an edge server.

Aspect 12. The energizing device of any one of Aspects 1 to 11, wherein each wireless communication device of the plurality of wireless communication devices is an electronic shelf label (ESL).

Aspect 13. The energizing device of any one of Aspects 1 to 12, wherein the computing device is an ambient internet of things (IOT) device.

Aspect 14. A method for wireless communication, the method comprising: synchronizing, by an energizing device, with a network device of a plurality of network devices based on at least one of received timing information transmitted from a network entity over a wired connection, a respective received signal strength of a respective beacon transmitted from each network device of the plurality of network devices, or a respective received signal strength of a respective beacon transmitted from each wireless communication device of a plurality of wireless communication devices, wherein each wireless communication device of the plurality of wireless communication devices is associated with at least one network device of the plurality of network devices; and transmitting, by the energizing device to a computing device, an energizer transmission indicating timing for synchronization of the computing device to the energizing device.

Aspect 15. The method of Aspect 14, wherein the timing information is associated with the network device.

Aspect 16. The method of any one of Aspects 14 or 15, wherein synchronizing with the network device of the plurality of network devices is based on a signal strength of a beacon transmitted from the network device being greater than signal strengths of beacons transmitted from other network devices of the plurality of network devices.

Aspect 17. The method of any one of Aspects 14 to 16, wherein each respective signal strength of each respective beacon is a received signal strength indicator (RSSI).

Aspect 18. The method of any one of Aspects 14 to 17, wherein a subset of wireless communication devices of the plurality of wireless communication devices are associated with the network device.

Aspect 19. The method of any one of Aspects 14 to 18, wherein synchronizing with the network device of the plurality of network devices is based on received signal strengths of beacons transmitted from the subset of wireless communication devices of the plurality of wireless communication devices being greater than signal strengths of beacons transmitted from other wireless communication devices of the plurality of wireless communication devices.

Aspect 20. The method of any one of Aspects 14 to 19, wherein each respective beacon transmitted by each wireless communication device of the plurality of wireless communication devices comprises a respective identification (ID) of an associated network device of the plurality of network devices.

Aspect 21. The method of any one of Aspects 14 to 20, wherein an end of the energizer transmission indicates a boundary between time slots of a time grid associated with the timing for the synchronization of the computing device to the energizing device.

Aspect 22. The method of any one of Aspects 14 to 21, wherein the energizer transmission comprises a waveform with a pattern indicating a boundary between time slots of a time grid associated with the timing for the synchronization of the computing device to the energizing device.

Aspect 23. The method of any one of Aspects 14 to 22, wherein each network device of the plurality of network devices is an access point (AP).

Aspect 24. The method of any one of Aspects 14 to 23, wherein the network entity is an edge server.

Aspect 25. The method of any one of Aspects 14 to 24, wherein each wireless communication device of the plurality of wireless communication devices is an electronic shelf label (ESL).

Aspect 26. The method of any one of Aspects 14 to 25, wherein the computing device is an ambient internet of things (IOT) device.

Aspect 27. A non-transitory computer-readable medium having stored thereon instructions that, when executed by one or more processors, cause the one or more processors to perform operations according to any of Aspects 14 to 26.

Aspect 28. An apparatus for wireless communication, the apparatus including one or more means for performing operations according to any of Aspects 14 to 26.

Aspect 29. A network device for wireless communication, the network device comprising: at least one memory; and at least one processor coupled to the at least one memory and configured to: determine a position for a computing device based on signal strengths measured by a plurality of wireless communication devices of signals transmitted from the computing device; and increase a synchronization accuracy of the plurality of wireless communication devices with the network device and the computing device based on at least one of increasing a frequency of transmission of beacons by the network device, or indicating to a subset of wireless communication devices of the plurality of wireless communication devices located in proximity to the position for the computing device to wake up to receive transmissions more frequently than scheduled according to a predetermined time grid.

Aspect 30. The network device of Aspect 29, wherein the network device is an access point (AP), the computing device is an ambient internet of things (IOT) device, and each wireless communication device of the plurality of wireless communication devices is an electronic shelf label (ESL).

Aspect 31. A method for wireless communication, the method comprising: determining, by a network device, a position for a computing device based on signal strengths measured by a plurality of wireless communication devices of signals transmitted from the computing device; and increasing, by the network device, a synchronization accuracy of the plurality of wireless communication devices with the network device and the computing device based on at least one of increasing a frequency of transmission of beacons by the network device, or indicating to a subset of wireless communication devices of the plurality of wireless communication devices located in proximity to the position for the computing device to wake up to receive transmissions more frequently than scheduled according to a predetermined time grid.

Aspect 32. The method of Aspect 31, wherein the network device is an access point (AP), the computing device is an ambient internet of things (IOT) device, and each wireless communication device of the plurality of wireless communication devices is an electronic shelf label (ESL).

Aspect 33. A non-transitory computer-readable medium having stored thereon instructions that, when executed by one or more processors, cause the one or more processors to perform operations according to any of Aspects 31 or 32.

Aspect 34. An apparatus for wireless communication, the apparatus including one or more means for performing operations according to any of Aspects 31 or 32.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An energizing device for wireless communication, the energizing device comprising:
at least one memory; and
at least one processor coupled to the at least one memory and configured to:
synchronize with a network device of a plurality of network devices based on at least one of received timing information transmitted from a network entity over a wired connection, a respective received signal strength of a respective beacon transmitted from each network device of the plurality of network devices, or a respective received signal strength of a respective beacon transmitted from each wireless communication device of a plurality of wireless communication devices, wherein each wireless communication device of the plurality of wireless communication devices is associated with at least one network device of the plurality of network devices; and
output, for transmission to a computing device, an energizer transmission indicating timing for synchronization of the computing device to the energizing device.

2. The energizing device of claim 1, wherein the timing information is associated with the network device.

3. The energizing device of claim 1, wherein the at least one processor is configured to synchronize with the network device of the plurality of network devices based on a signal strength of a beacon transmitted from the network device being greater than signal strengths of beacons transmitted from other network devices of the plurality of network devices.

4. The energizing device of claim 1, wherein each respective signal strength of each respective beacon is a received signal strength indicator (RSSI).

5. The energizing device of claim 1, wherein a subset of wireless communication devices of the plurality of wireless communication devices are associated with the network device.

6. The energizing device of claim 5, wherein the at least one processor is configured to synchronize with the network device of the plurality of network devices based on received signal strengths of beacons transmitted from the subset of wireless communication devices of the plurality of wireless communication devices being greater than signal strengths of beacons transmitted from other wireless communication devices of the plurality of wireless communication devices.

7. The energizing device of claim 1, wherein each respective beacon transmitted by each wireless communication device of the plurality of wireless communication devices comprises a respective identification (ID) of an associated network device of the plurality of network devices.

8. The energizing device of claim 1, wherein an end of the energizer transmission indicates a boundary between time slots of a time grid associated with the timing for the synchronization of the computing device to the energizing device.

9. The energizing device of claim 1, wherein the energizer transmission comprises a waveform with a pattern indicating a boundary between time slots of a time grid associated with the timing for the synchronization of the computing device to the energizing device.

10. The energizing device of claim 1, wherein each network device of the plurality of network devices is an access point (AP).

11. The energizing device of claim 1, wherein the network entity is an edge server.

12. The energizing device of claim 1, wherein each wireless communication device of the plurality of wireless communication devices is an electronic shelf label (ESL).

13. The energizing device of claim 1, wherein the computing device is an ambient internet of things (IOT) device.

14. A method for wireless communication, the method comprising:
synchronizing, by an energizing device, with a network device of a plurality of network devices based on at least one of received timing information transmitted from a network entity over a wired connection, a respective received signal strength of a respective beacon transmitted from each network device of the plurality of network devices, or a respective received signal strength of a respective beacon transmitted from each wireless communication device of a plurality of wireless communication devices, wherein each wireless communication device of the plurality of wireless communication devices is associated with at least one network device of the plurality of network devices; and
transmitting, by the energizing device to a computing device, an energizer transmission indicating timing for synchronization of the computing device to the energizing device.

15. The method of claim 14, wherein the timing information is associated with the network device.

16. The method of claim 14, wherein synchronizing with the network device of the plurality of network devices is based on a signal strength of a beacon transmitted from the network device being greater than signal strengths of beacons transmitted from other network devices of the plurality of network devices.

17. The method of claim 14, wherein each respective signal strength of each respective beacon is a received signal strength indicator (RSSI).

18. The method of claim 14, wherein a subset of wireless communication devices of the plurality of wireless communication devices are associated with the network device.

19. The method of claim 18, wherein synchronizing with the network device of the plurality of network devices is based on received signal strengths of beacons transmitted from the subset of wireless communication devices of the plurality of wireless communication devices being greater than signal strengths of beacons transmitted from other wireless communication devices of the plurality of wireless communication devices.

20. The method of claim 14, wherein each respective beacon transmitted by each wireless communication device of the plurality of wireless communication devices comprises a respective identification (ID) of an associated network device of the plurality of network devices.

21. The method of claim 14, wherein an end of the energizer transmission indicates a boundary between time slots of a time grid associated with the timing for the synchronization of the computing device to the energizing device.

22. The method of claim 14, wherein the energizer transmission comprises a waveform with a pattern indicating a boundary between time slots of a time grid associated with the timing for the synchronization of the computing device to the energizing device.

23. The method of claim 14, wherein each network device of the plurality of network devices is an access point (AP).

24. The method of claim 14, wherein the network entity is an edge server.

25. The method of claim 14, wherein each wireless communication device of the plurality of wireless communication devices is an electronic shelf label (ESL).

26. The method of claim 14, wherein the computing device is an ambient internet of things (IOT) device.

27. A network device for wireless communication, the network device comprising:
at least one memory; and
at least one processor coupled to the at least one memory and configured to:
determine a position for a computing device based on signal strengths measured by a plurality of wireless communication devices of signals transmitted from the computing device; and
increase a synchronization accuracy of the plurality of wireless communication devices with the network device and the computing device based on at least one of increasing a frequency of transmission of beacons by the network device, or indicating to a subset of wireless communication devices of the plurality of wireless communication devices located in proximity to the position for the computing device to wake up to receive transmissions more frequently than scheduled according to a predetermined time grid.

28. The network device of claim 27, wherein the network device is an access point (AP), the computing device is an ambient internet of things (IOT) device, and each wireless communication device of the plurality of wireless communication devices is an electronic shelf label (ESL).

29. A method for wireless communication, the method comprising:
determining, by a network device, a position for a computing device based on signal strengths measured by a plurality of wireless communication devices of signals transmitted from the computing device; and
increasing, by the network device, a synchronization accuracy of the plurality of wireless communication devices with the network device and the computing device based on at least one of increasing a frequency of transmission of beacons by the network device, or indicating to a subset of wireless communication devices of the plurality of wireless communication devices located in proximity to the position for the computing device to wake up to receive transmissions more frequently than scheduled according to a predetermined time grid.

30. The method of claim 29, wherein the network device is an access point (AP), the computing device is an ambient internet of things (IOT) device, and each wireless communication device of the plurality of wireless communication devices is an electronic shelf label (ESL).
